(19) United States
(12) Patent Application Publication
(10) Pub. No.: US 2014/0223570 A1
(43) Pub. Date: Aug. 7, 2014

(54) INFORMATION PROCESSING APPARATUS, INFORMATION PROCESSING SYSTEM, AND LICENSE MANAGEMENT METHOD

(71) Applicants: Hiroyuki MATSUSHIMA, Kanagawa (JP); Yohei Fujita, Kanagawa (JP); Yukiko Kaida, Tokyo (JP)

(72) Inventors: Hiroyuki MATSUSHIMA, Kanagawa (JP); Yohei Fujita, Kanagawa (JP); Yukiko Kaida, Tokyo (JP)

(73) Assignee: RICOH COMPANY, LTD., Tokyo (JP)

(21) Appl. No.: 14/168,086

(22) Filed: Jan. 30, 2014

(30) Foreign Application Priority Data
Feb. 6, 2013 (JP) 2013-021834
Dec. 12, 2013 (JP) 2013-257095

(51) Int. Cl. G06F 21/10

(52) U.S. Cl. CPC G06F 21/105
USPC 726/26

(57) ABSTRACT

An information processing system including one or more information processing apparatus includes one or more service providing units to provide a service to a first terminal device; and a license management unit to manage a license temporarily registered from a second terminal device. The service providing unit includes a first storage unit to preserve license information of the license managed by the license management unit; a second storage unit to store a copy of the license information; and a validation unit to receive a request to make the license valid from the first terminal device, to make the temporarily registered license information stored in the second storage unit valid, and to request to make the temporarily registered license information preserved in the first storage unit valid. The service is provided for the first terminal device based on the license having made valid.

### BACKGROUND OF THE INVENTION

1. Field of the Invention

The disclosures herein generally relate to an information processing system, an information processing apparatus, and a license management method.

2. Description of the Related Art

For example, as a method of controlling a license on an information processing apparatus, a conventional license management system has been known that responds to a request for using a licensed software program. Such a conventional license management system includes a function for managing information about an application and a device that executes the application. Such a conventional license management system manages a license so that an application is set valid to be executed on a device that is granted for execution (see, for example, Patent Document 1).

In recent years, a new form of service has been increasingly offered with which a user uses a needed function only when it is needed. Such a new form of software usage includes, for example, SaaS (Software as a Service) with which a user can freely select only a desired function to use, and cloud computing that provides high added-value services for end users by combining computing resources on the Internet.

For using such a service described above, a user purchases, for example, a license from a sales company of the service. The sales company of the service manages the license issued for the user, for example, by a business system. A service providing system that offers the service determines whether to allow offering the service to the user based on the license issued by the business system. However, license management is not easy, for example, if there are multiple business systems for license issuance that are provided by individual sales companies.

### PATENT DOCUMENTS

[Patent Document 1] Japanese Laid-open Patent Publication No. 2006-18770

### SUMMARY OF THE INVENTION

In view of the above, it is a general object of at least one embodiment of the present invention to provide an image processing apparatus, an information processing system, and a license management method that can make license management easier.

According to at least one embodiment of the present invention, an information processing system including one or more information processing apparatus, includes one or more service providing units to provide a service to a first terminal device; and a license management unit to manage a license temporarily registered from a second terminal device. The service providing unit includes a first storage unit to preserve license information of the license managed by the license management unit; a second storage unit to store a copy of the license information of the license; and a validation unit to receive a request to make the license valid from the first terminal device, to make the temporarily registered license information of the license stored in the second storage unit valid, and to request to make the temporarily registered license information of the license preserved in the first storage unit valid. The service is provided for the first terminal device based on the license having made valid.

According to at least one embodiment of the present invention, it is possible to make license management easier.

### BRIEF DESCRIPTION OF DRAWINGS

FIG. 1 is a configuration diagram of an example of an information processing system according to a first embodiment;

FIG. 2 is a configuration diagram of another example of a service providing system;

FIG. 3 is a hardware configuration diagram of an example of a computer system;

FIG. 4 is a process block diagram of an example of a service providing system according to the first embodiment;

FIG. 5 is a process block diagram of another example of a service providing system according to the first embodiment;

FIG. 6 is a schematic view illustrating license information in a business license management device and a common service providing device;

FIG. 7 is a schematic view illustrating license information in a business license management device and common service providing devices;

FIG. 8 is a schematic view illustrating APIs used by a business license management device and a common service providing device;

FIG. 9 is a schematic view illustrating APIs used by a business license management device and common service providing devices;

FIG. 10 is a configuration diagram of an example of organization information;

FIG. 11 is a configuration diagram of an example of user information;

FIG. 12 is a configuration diagram of an example of license information;

FIG. 13 is a configuration diagram of an example of device information;

FIG. 14 is a schematic view illustrating dates included in license information;

FIG. 15 is a schematic view illustrating a valid term and a nominal term of a license;

FIG. 16 is a sequence chart of an example of a procedure for issuing an organization ID;

FIG. 17 is a schematic view illustrating an example of an organization ID issuance screen;

FIG. 18 is a sequence chart of an example of a procedure for opening an organization;

FIG. 19 is a sequence chart of an example of a procedure for issuing a service ID;

FIG. 20 is a sequence chart of an example of a procedure for registering a service ID;

FIG. 21 is a sequence chart of an example of a procedure for updating a contracted service;

FIG. 22, is a sequence chart of an example of a procedure for canceling an organization;

FIG. 23 is a sequence chart of an example of a procedure for canceling a service;

FIG. 24 is a sequence chart of an example of a procedure for continuing a service coming to an end;

FIG. 25 is a schematic view illustrating an example of a terms-of-use screen;

FIG. 26 is a schematic view illustrating an example of a URL issuance screen;

FIG. 27 is a schematic view illustrating an example of an input content confirmation screen;

FIG. 28 is a schematic view illustrating an example of a URL indication screen;

FIG. 29 is a schematic view illustrating an example of an organization information input screen;

FIG. 30 is a schematic view illustrating an example of an input content confirmation screen;

FIG. 31 is a schematic view illustrating an example of an opening result indication screen;

FIG. 32 is a schematic view illustrating an example of a service registration screen;

FIG. 33 is a schematic view illustrating an example of a service management screen before service registration;

FIG. 34 is a schematic view illustrating an example of a service management screen after service registration;

FIG. 35 is a schematic view illustrating an example of a service ID input screen for license update;

FIG. 36 is a schematic view illustrating an example of a terms-of-use screen for license update;

FIG. 37 is a schematic view illustrating an example of a service selection screen for license update;

FIG. 38 is a schematic view illustrating an example of a confirmation screen for license update;

FIG. 39 is a schematic view illustrating an example of a closing screen for license update;

FIG. 40 is a schematic view illustrating an example of a service management screen after license update;

FIG. 41 is a schematic view illustrating an example of a service management screen where a service is continued by updating a license;

FIG. 42 is a schematic view illustrating an example of a service selection screen;

FIG. 43 is a sequence chart of an example of a procedure for preserving service authorization information;

FIG. 44 is a schematic view illustrating a configuration diagram of an example a service authorization table;

FIG. 45 is a flowchart of an example of a procedure for updating service authorization table;

FIG. 46 is a flowchart of another example of a procedure for updating service authorization table;

FIG. 47 is a schematic view illustrating an example of a service ID change screen;

FIG. 48 is a sequence chart of an example of a procedure for generating a service selection screen; and

FIG. 49 is a sequence chart of an example of a procedure for determining whether to allow service execution.

### DETAILED DESCRIPTION OF THE PREFERRED EMBODIMENTS

In the following, embodiments of the present invention will be described with reference to the accompanying drawings.

### First Embodiment

<System Configuration>

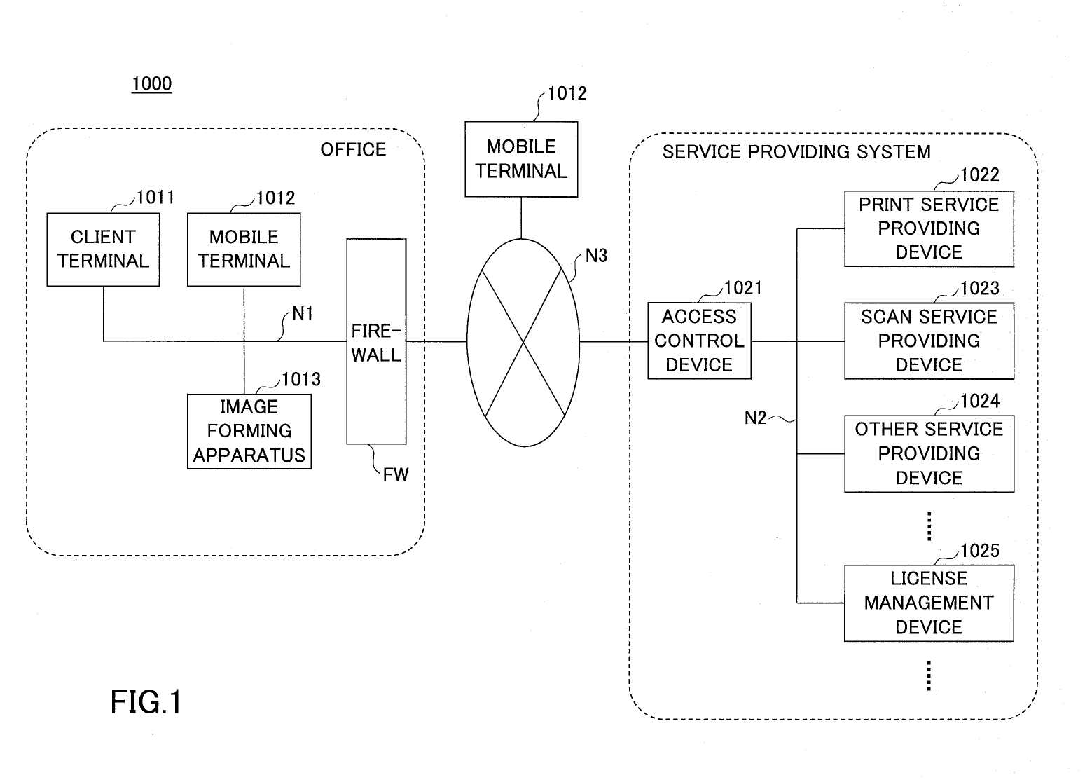

FIG. 1 is a configuration diagram of an example of an information processing system according to a first embodiment. The information processing system 1000 illustrated in FIG. 1 includes, for example, a network N1 such as a network in an office, a network N2 of a service providing system represented by a cloud service, and a network N3 such as the Internet.

The network N1 is a private network behind a firewall FW. The firewall FW is installed at a contact point between the network N1 and the network N3, and detects and blocks unauthorized access. To the network N1, a client terminal 1011, a mobile terminal 1012, and an image forming apparatus 1013 such as a multifunction peripheral are connected.

The client terminal 1011 is an example of a terminal device. The client terminal 1011 is realized by an information processing apparatus in which a typical OS is installed. The client terminal 1011 includes a unit for performing radio communication or a unit for performing cable communication. The client terminal 1011 is a terminal that can be operated by a user, such as a tablet PC and a notebook PC.

The mobile terminal 1012 is an example of a terminal device. The mobile terminal 1012 includes a unit for performing radio communication or a unit for performing cable communication. The mobile terminal 1012 is a terminal that is portable for a user, such as a smartphone, a mobile phone, a tablet PC, and a notebook PC.

The image forming apparatus 1013 is a device having an image forming function, such as a multifunction peripheral. The image forming apparatus 1013 includes a unit for performing radio communication or a unit for performing cable communication. The image forming apparatus 1013 is a device for performing processes relevant to image formation, such as a multifunction peripheral, a copier, a scanner, a printer, a laser printer, a projector, and an electronic blackboard. FIG. 1 illustrates an example including one of each of the client terminal 1011, the mobile terminal 1012, and the image forming apparatus 1013. There may be a plurality of each of these devices.

The network N2 is connected with the network N3 via an access control device 1021. The security of the network N2 is protected by the access control device 1021. To the network N2, a print service providing device 1022, a scan service providing device 1023, other service providing device 1024, and a license management device 1025 are connected.

In the information processing system 1000 of FIG. 1, the access control device 1021, the print service providing device 1022, the scan service providing device 1023, the other service providing device 1024, and the license management device 1025 realize the service providing system. The print service providing device 1022, the scan service providing device 1023, and the other service providing device 1024 provide a print service, a scan service, and other services, respectively. The license management device 1025 executes procedures for license management.

The access control device 1021 controls a log-in operation to a print service provided by the print service providing device 1022 and a scan service provided by the scan service providing device 1023.

The access control device 1021, the print service providing device 1022, the scan service providing device 1023, the other service providing device 1024, and the license management device 1025 are realized by one or more information processing apparatus.

The access control device 1021, the print service providing device 1022, the scan service providing device 1023, the other service providing device 1024, and the license management device 1025 may be realized by being integrated in a single information processing apparatus, or may be realized by being distributed across a plurality of information processing apparatuses.

Part of the services on the network N2 side may be outside the network N2. The mobile terminal 1012 may be outside the network N1 that is a network inside the office. In the example of the information processing system 1000 of FIG. 1, the mobile terminal 1012 is in the network N1 and in the network N3.

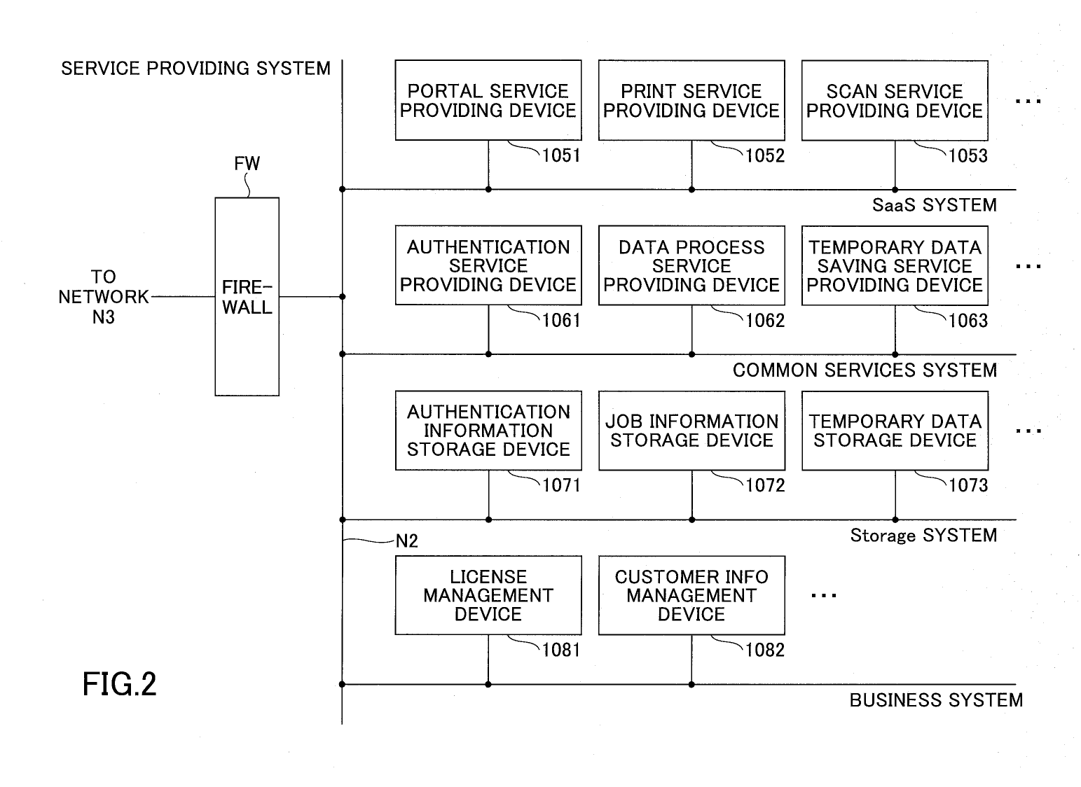

The configuration of the service providing system of FIG. 1 is one example. The service providing system may be realized by a configuration illustrated in FIG. 2. FIG. 2 is a configuration diagram of another example of the service providing system. In the service providing system of FIG. 2, the network N2 is connected to the network N3 by a firewall FW.

In the network N2, service providing devices of a SaaS (Software as a Service) system, service providing devices of a common service (Network Service Platform) system, and storage devices of the storage system are connected. The service providing devices of the common service system provides services that can be commonly used by the service providing devices of the SaaS system.

The service providing devices of the SaaS system include service providing devices according to the service to be provided, such as a portal service providing device 1051, a print service providing device 1052, and a scan service providing device 1053. Furthermore, the service providing devices of the common service system include service providing devices according to a common service to be provided, such as an authentication service providing device 1061, a data process service providing device 1062, and a temporary data saving service providing device 1063.

The storage devices of the storage system include storage devices according to the information (data) to be stored, such as an authentication information storage device 1071, a job information storage device 1072, and a temporary data storage device 1073. The business management device includes management devices according to the information to be managed, such as a license management device 1081 and a customer information management device 1082.

In the service providing system of FIG. 2, security is protected by authentication services provided by, for example, the firewall FW and the authentication service providing device 1061. Note that the configuration of the service providing system of FIG. 2 is also one example, and the service providing system may have other configurations. The devices, terminals, and networks that constitute the service providing system illustrated in FIGS. 1-2 may be built on a virtual environment.

<Hardware Configuration>

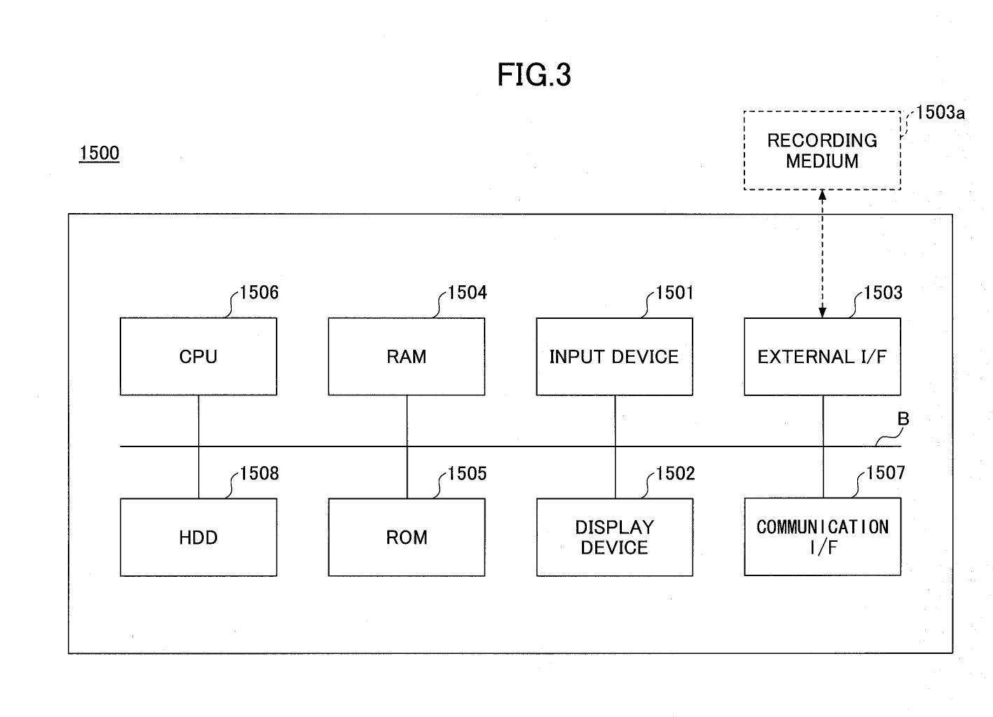

The client terminal 1011 and the mobile terminal 1012 in FIG. 1 are realized by, for example, a computer system having a hardware configuration as illustrated in FIG. 3. The access control device 1021, the print service providing device 1022, the scan service providing device 1023, the other service providing device 1024, and the license management device 1025 are also realized by, for example, a computer system having a hardware configuration as illustrated in FIG. 3.

The service providing devices of the SaaS system, the service providing devices of the common service system, and the storage devices of the storage system illustrated in FIG. 2 may also be realized by, for example, a computer system having a hardware configuration as illustrated in FIG. 3.

FIG. 3 is a hardware configuration diagram of an example of a computer system. A computer system 1500 illustrated in FIG. 3 includes an input device 1501, a display device 1502, an external I/F 1503, a RAM 1504, a ROM 1505, a CPU 1506, a communication I/F 1507, and an HDD 1508, which are interconnected by a bus B.

The input device 1501 includes a keyboard, a mouse, and a touch panel, which are used by a user for inputting operation signals. The display device 1502 includes a display, etc., and displays processing results obtained by the computer system 1500.

The communication I/F 1507 is an interface for connecting the computer system 1500 to the networks N1 through N3. Accordingly, the computer system 1500 can perform data communication via the communication I/F 1507.

The HDD (Hard Disk Drive) 1508 is a nonvolatile storage device storing programs and data. Examples of stored programs and data are an OS (Operating System) which is basic software for controlling the entire computer system 1500, and application software for providing various functions on the OS.

The HDD 1508 manages the stored programs and data by a predetermined file system and/or a DB (database). The external I/F 1503 is an interface between the computer system 1500 and an external device. An example of the external device is a recording medium 1503a. Accordingly, the computer system 1500 can read data from and/or write data in the recording medium 1503a via the external I/F 1503.

Examples of the recording medium 1503a are a flexible disk, a CD (Compact Disk), and a DVD (Digital Versatile Disk). Examples of the recording medium 1503a also include an SD memory card and a USB memory (Universal Serial Bus memory).

The ROM (Read-Only Memory) 1505 is a nonvolatile semiconductor memory (storage device) that can hold programs and data even after the power is turned off. The ROM 1505 stores programs and data such as BIOS (Basic Input/Output System) that is executed when the computer system 1500 is activated, OS settings, and network settings.

The RAM (Random Access Memory) 1504 is a volatile semiconductor memory (storage device) for temporarily storing programs and data. The CPU (Central Processing Unit) 1506 is a processor for loading the programs and data from storage devices such as the ROM 1505 and the HDD 1508 into the RAM 1504, and executing processes to control the entire computer system 1500 and to realize functions.

The client terminal 1011 and the mobile terminal 1012 can realize various processes as described below by the hardware configuration of the computer system 1500. The access control device 1021, the print service providing device 1022, the scan service providing device 1023, and the other service providing device 1024 can also realize various processes as described below by the hardware configuration of the computer system 1500. Furthermore, the service providing device of the SaaS system, the service providing device of the common service system, and the storage device of the storage system can also realize various processes as described below, by the hardware configuration of the computer system 1500. Note that descriptions of hardware configurations of the image forming apparatus 1013 and the firewall FW illustrated in FIG. 1 are omitted.

<Software Configuration>

<<Service Providing System>>

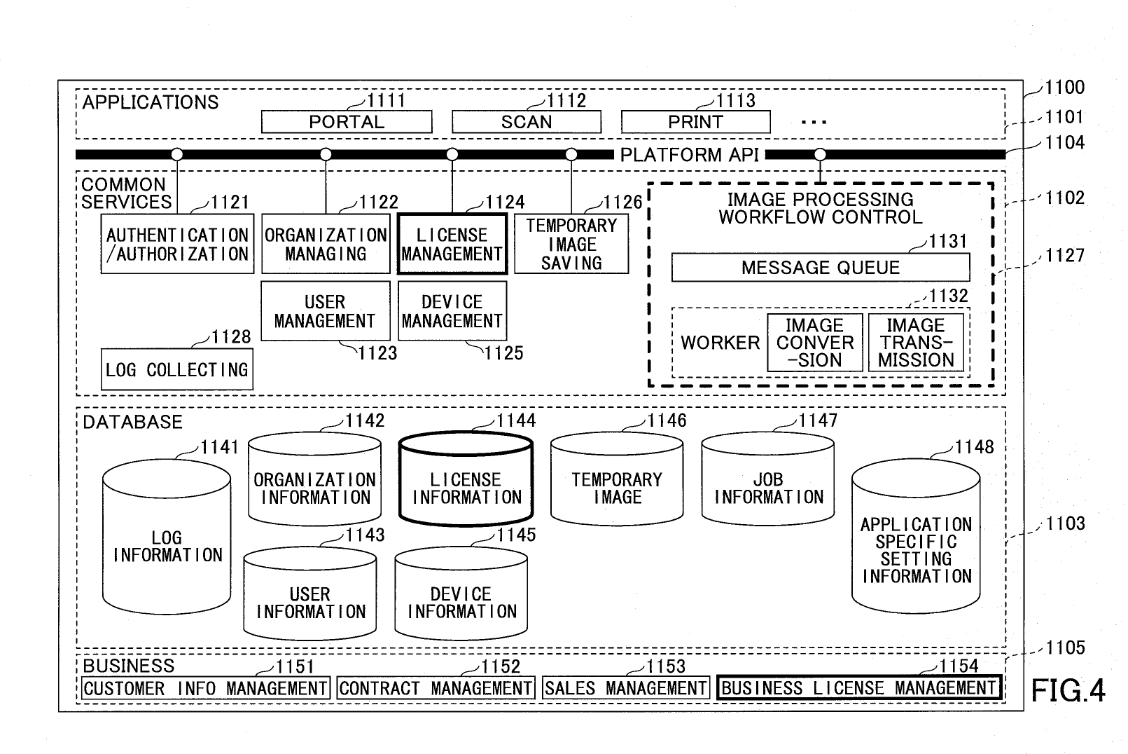

The service providing system according to the first embodiment is realized by, for example, process blocks as illustrated in FIG. 4. FIG. 4 is a process block diagram of an example of the service providing system according to the first embodiment. The service providing system 1100 realizes the processes illustrated in FIG. 4 by executing programs.

The service providing system 1100 in FIG. 4 realizes applications 1101, common services 1102, a database (DB) 1103, a platform API 1104, and business services 1105.

The applications 1101 include, for example, a portal service application 1111, a scan service application 1112, and a print service application 1113.

The portal service application 1111 is an application for providing a portal service. A portal service provides a service acting as an entrance for using the service providing system 1100. The scan service application 1112 is an application for providing a scan service. The print service application 1113 is an application for providing a print application. The applications 1101 may include other service applications.

The platform API (Application Programming Interface) 1104 is an interface for using the common services 1102 by the applications 1101 including the portal service application 1111 and the like. The platform API 1104 is an interface that is defined in advance, which is provided for the common services 1102 to receive requests from the applications 1101. The platform API 1104 is constituted by, for example, functions and classes.

The platform API 1104 is realized by, for example, a Web API that can be used via the network, when the service providing system 1100 is constituted by multiple information processing apparatuses.

The common services 1102 include an authentication/authorization unit 1121, an organization managing unit 1122, a user management unit 1123, a service providing license management unit 1124, a device management unit 1125, a temporary image saving unit 1126, an image processing workflow control unit 1127, and a log collecting unit 1128.

Furthermore, the image processing workflow control unit 1127 includes a message queue 1131, and at least one worker 1132. The worker 1132 realizes functions such as image conversion and image transmission.

The authentication/authorization unit 1121 executes authentication/authorization based on a log in request from office devices such as the client terminal 1011 and the image forming apparatus 1013. The office device is a collective term of the client terminal 1011, the mobile terminal 1012, and the image forming apparatus 1013.

The authentication/authorization unit 1121 authenticates/authorizes a user by accessing, for example, a user information storage unit 1143, a license information storage unit 1144, and an authority information storage unit 1147, described below. Furthermore, the authentication/authorization unit 1121 authenticates, for example, the image forming apparatus 1013 by accessing, for example, the organization information storage unit 1142, the license information storage unit 1144, and the device information storage unit 1145, described below.

The organization managing unit 1122 manages organization information stored in an organization information storage unit 1142 described below. The user management unit 1123 manages user information stored in the user information storage unit 1143 described below. Furthermore, the user management unit 1123 manages authority information stored in the authority information storage unit 1147 described below.

The service providing license management unit 1124 manages license information stored in the license information storage unit 1144 described below. The device management unit 1125 manages device information stored in a device information storage unit 1145 described below. The temporary image preservation unit 1126 saves temporary images in a temporary image storage unit 1146 described below, and acquires temporary images from the temporary image storage unit 1146.

The image processing workflow control unit 1127 controls a workflow relevant to image processing, based on a request from the applications 1101. The message queue 1131 includes a queue corresponding to the type of process. The image processing workflow control unit 1127 submits the message of the request relevant to the process (job), in the queue corresponding to the type of the job.

The worker 1132 monitors the corresponding queue. When a message is submitted in the queue, the worker 1132 performs a process such as image conversion and image transmission according to the type of the corresponding job. Note that the submitted message may be subjectively read (pulled) by the worker 1132, or may be provided (pushed) from the queue to the worker 1132.

The database 1103 includes a log information storage unit 1141, an organization information storage unit 1142, a user information storage unit 1143, a license information storage unit 1144, a device information storage unit 1145, a temporary image storage unit 1146, a job information storage unit 1147, and an application-specific setting information storage unit 1148.

The log information storage unit 1141 stores log information. The organization information storage unit 1142 stores organization information described below. The user information storage unit 1143 stores user information described below. The license information storage unit 1144 stores license information. The device information storage unit 1145 stores device information described below.

The temporary image storage unit 1146 stores temporary images. A temporary image is, for example, a file or data of a scan image to be processed by the worker 1132. The job information storage unit 1147 stores information (job information) of a request relevant to a process (job). The application-specific setting information storage unit 1148 stores setting information specific to the application 1101.

The business service 1105 includes a customer information management unit 1151, a contract management unit 1152, a sales management unit 1153, and a business license management unit 1154. The customer information management unit 1151 manages customer information. The contract management unit 1152 manages contract information. The sales management unit 1153 manages sales information. The business license management unit 1154 manages license information. Note that the business license management unit 1154 includes a license DB for storing the license information.

The service providing system 1100 functions as an integrated base for providing common services such as a workflow relevant to authentication/authorization and image processing, and a group of services providing application services by using functions of the integrated base, such as a scan service, a print service, and a portal service.

The integrated base is constituted with, for example, the common services 1102, the database 1103, and the platform API 1104. Also, the group of services is constituted with, for example, the applications 1101. Thus, the service providing system 1100 illustrated in FIG. 4 has a configuration in which the applications 1101 and the business services 1105 are separated.

By configuring the service providing system 1100 so that the group of services and the integrated base are separated as illustrated in FIG. 4, it is easy to develop an application 1101 that uses the platform API 1104.

Note that process blocks in the service providing system 1100 illustrated in FIG. 4 are classified as an example. It is not a mandatory requirement for the applications 1101, common services 1102, DB 1103, and business services 1105 to be classified in the hierarchy as illustrated in FIG. 4. It is not limited to a specific classification such as the hierarchical relationship illustrated in FIG. 4, as long as processing for the service providing system 1100 can be executed according to the first embodiment.

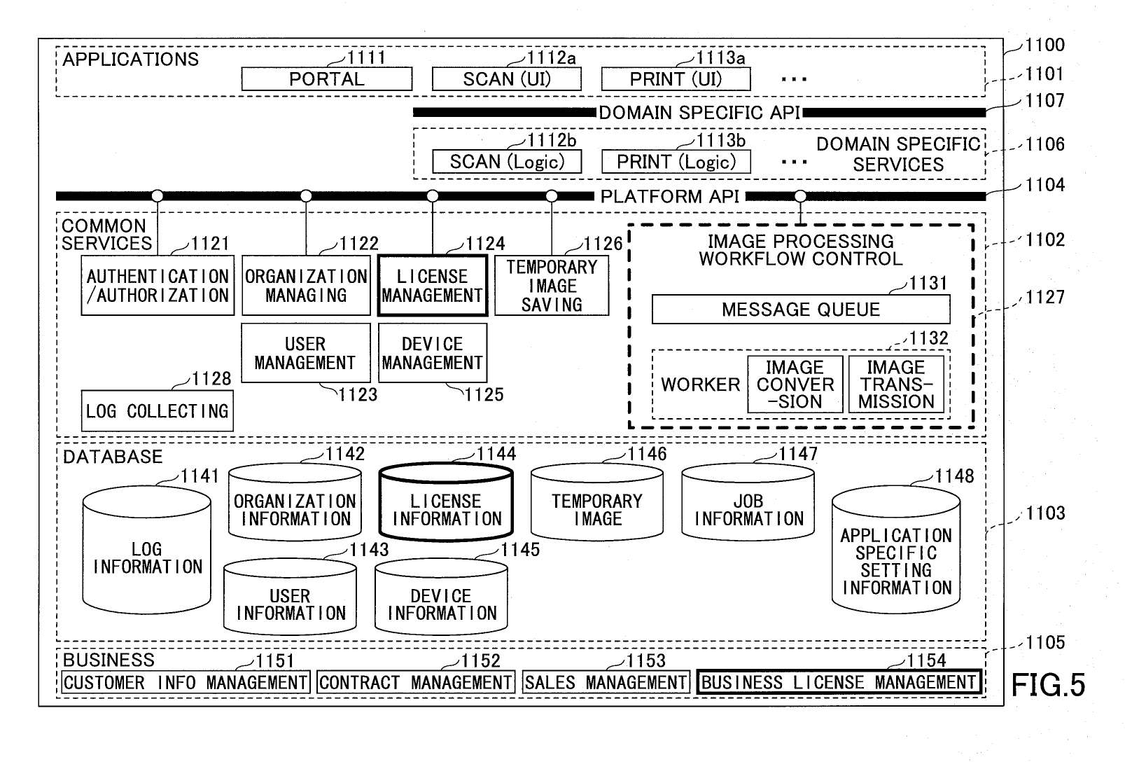

Note that the process blocks of the service providing system 1100 illustrated in FIG. 4 may be substituted with, for example, process blocks illustrated in FIG. 5. FIG. 5 is a process block diagram of another example of a service providing system according to the first embodiment. Note that the service providing system 1100 in FIG. 5 is substantially the same as the service providing system 1100 in FIG. 4 with a few exceptions, and description of the same part is omitted appropriately.

The service providing system 1100 in FIG. 5 implements a domain specific service 1106 and a domain specific API 1107 in addition to the process blocks in FIG. 4 by executing programs. The service providing system 1100 in FIG. 5 differs from the service providing system 1100 in FIG. 4 in the application 1101, the domain specific service 1106, and the domain specific API 1107. The application 1101 in FIG. 5 includes, for example, a portal service application 1111, a UI unit of the scan service application 1112a, and a UI unit of the print service application 1113a. The domain specific service 1106 includes, for example, a logic unit of the scan service application 1112b and a logic unit of the print service application 1113b.

Domain specific logic implemented as the logic unit of the scan service application 1112b and the logic unit of the print service application 1113b receives access from clients other than Web browsers, such as the portable terminal 1012 and the image forming apparatus 1013. In a client other than Web browsers, a UI unit such as the UI unit of the scan service application 1112a is provided on the client; hence a server only needs to provide the domain specific API 1107.

Thus, in the service providing system 1100 in FIG. 5, access from Web browsers is received by a UI unit such as the UI unit of the scan service application 1112a. Also, access from a client other than Web browsers is received by a logic unit such as the logic unit of the scan service application 1112b. Access frequencies are different between access from Web browsers and access from clients other than Web browsers; hence scale-out can be done effectively with an increase of access frequency by installing these on different servers. Also, in the service providing system 1100 in FIG. 5, a complex application can be built by using a combination of the domain specific API 1107.

As mentioned earlier, the service providing system 1100 illustrated in FIG. 4 or FIG. 5 includes license information stored in the license information storage unit 1144 and license information stored in the license DB of the business license management unit 1154.

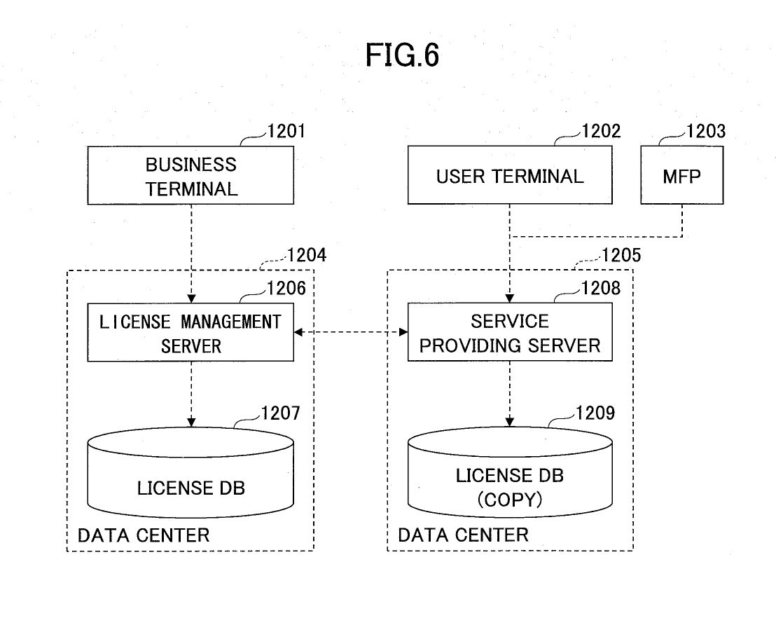

FIG. 6 is a schematic view illustrating license information in a business license management device and a common service providing device. In FIG. 6, a license DB 1209 represents the license information storage unit 1144 that stores license information. A license DB 1207 represents the license DB of the business license management unit 1154. The license DB 1207 is a master of the license information. Also, the license DB 1209 is a copy of the license information.

Note that a license management server 1206 represents the business license management unit 1154 in FIG. 6. The service providing server 1208 represents the applications 1101, the common service 1102, the database (DB) 1103 and the platform API 1104. The license management server 1206 and license DB 1207 are installed at, for example, a data center 1204 close to a business center (for example, a head office) to be managed in a unified way.

Also, the service providing server 1208 and license DB 1209 are installed at, for example, a data center 1205 close to users to improve response performance. There may be multiple sites of the data centers 1205 where the service providing servers 1208 and license DB 1209s are installed, respectively. The data center 1204 and data center 1205 are connected with each other via, for example, a dedicated network or a VPN communication channel, and have fire walls to restrict accessible servers.

A business terminal 1201 is a client terminal 1011 or the like operated by a person in charge of business. A user terminal 1202 is a client terminal 1011 or the like operated by a user such as an administrator. An MFP (combined machine) 1203 is an example of an image forming apparatus 1013.

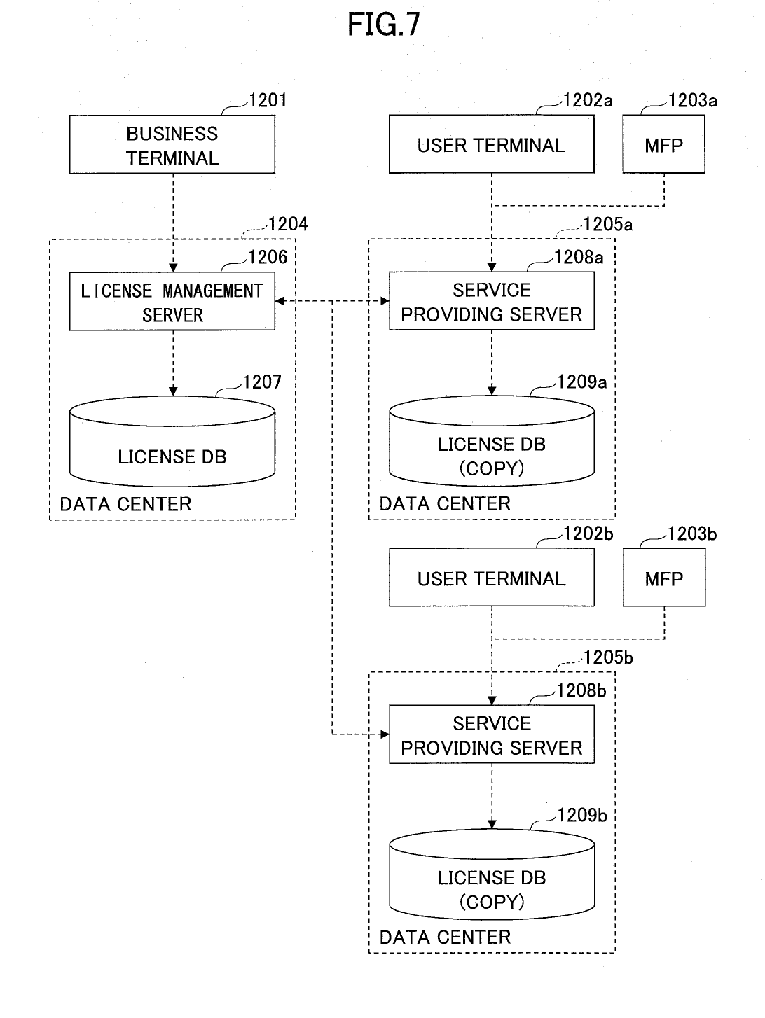

Note that if there are multiple sites of the data centers 1205, they are configured as illustrated in FIG. 7. FIG. 7 is a schematic view illustrating license information in a business license management device and common service providing devices. FIG. 7 illustrates a case where there are two sites of the data centers 1205a-1205b.

For example, the data centers 1205a-1205b are installed taking sales regions into account. Note that drawing lines between sales regions depends on a business form. One may consider, for example, regions of North America, Europe, and Japan.

In response to receiving a request for issuing license information in which a sales region is specified on the business terminal 1201, the license management server 1206 issues the license information, and indicates the issuance of the license information to one of the data centers 1205a-1205b corresponding to the specified sales region. Note that the license information issued by the license management server 1206 is assigned a license number that is unique across sales regions.

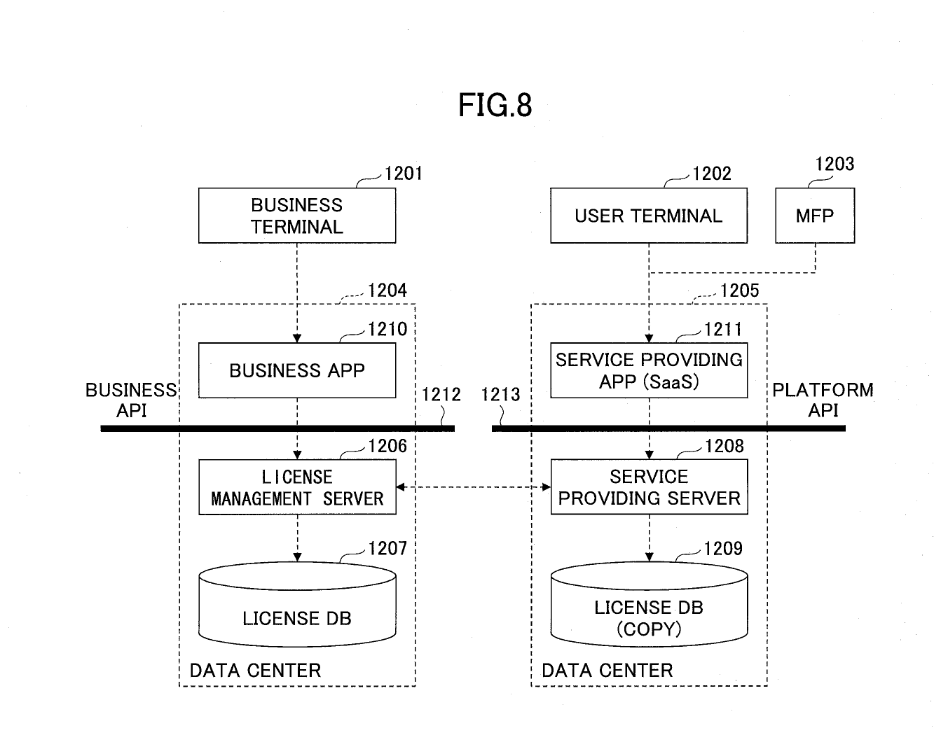

FIG. 8 is a schematic view illustrating APIs used by a business license management device and a common service providing device. FIG. 8 illustrates a configuration in which the configuration in FIG. 6 is added with a business application 1210, a service providing application 1211, a business API 1212, and a platform API 1213.

The business application 1210 is an application used by a person in charge of business. The business API 1212 is an API for executing, for example, license issuance, cancellation, and change that can be used by the business application 1210. The license management server 1206 includes the business API 1212. The service providing application 1211 is an application used by a user such as an administrator. The platform API 1213 is an API for executing, for example, license reference, search, and change that can be used by the service providing application 1211. The service providing server 1208 includes the platform API 1213.

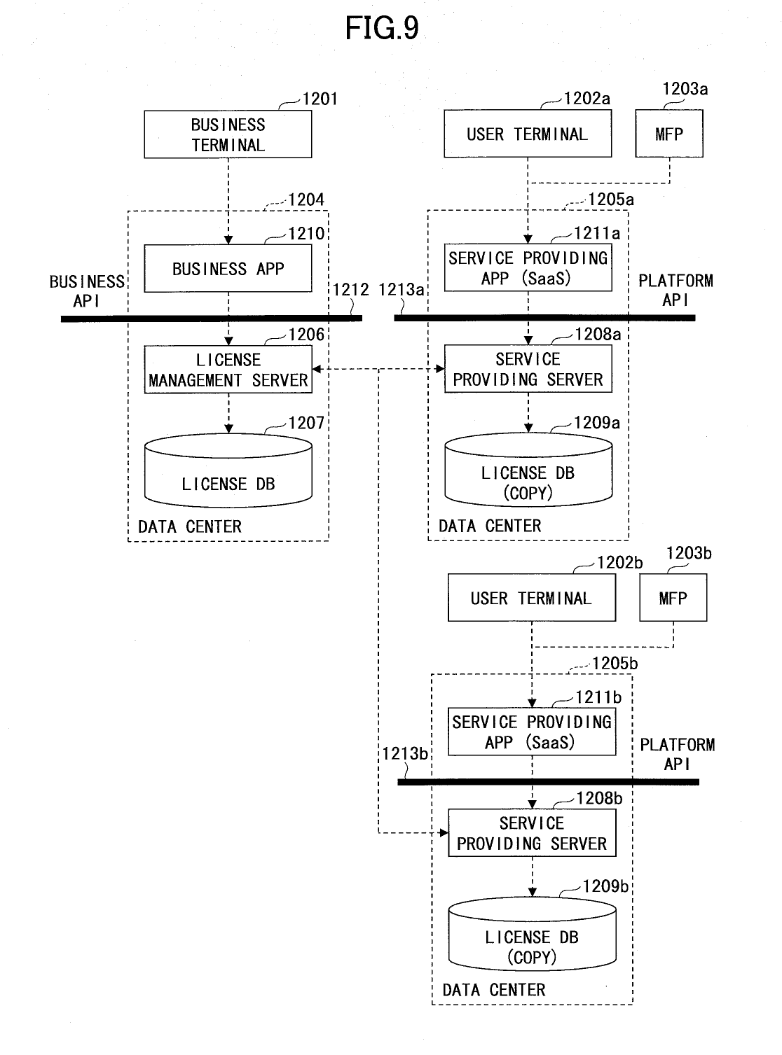

Note that if there are multiple sites of the data centers 1205, they are configured as illustrated in FIG. 9. FIG. 9 is a schematic view illustrating APIs used by a business license management device and common service providing devices. FIG. 9 illustrates a case where there are two sites of the data centers 1205a-1205b.

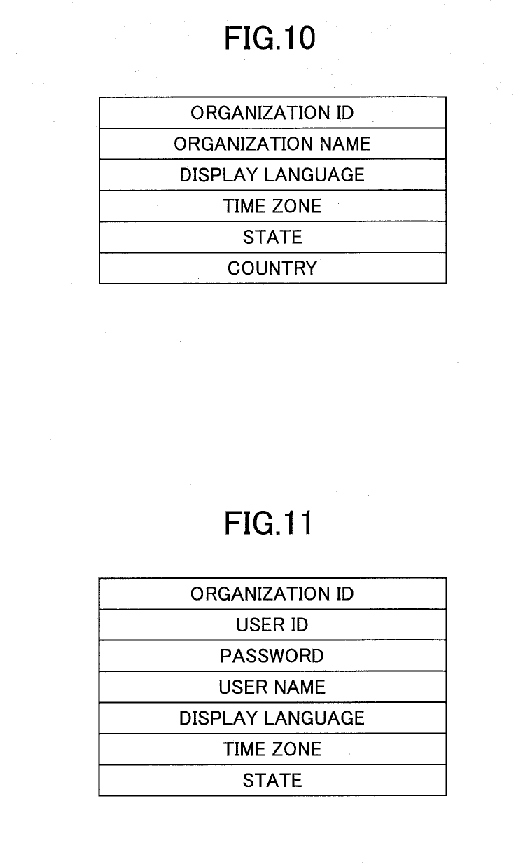

FIG. 10 is a configuration diagram of an example of organization information. The organization information illustrated in FIG. 10 includes, as data items, an organization ID, an organization name, a display language, the time zone, a state, and a country. The organization ID is information for identifying a group such as a company and a department. The organization ID is not limited to the word “organization”; for example, the information may be for identifying a contract. Note that the organization ID is unique.

The organization name expresses the name of a group such as a company and a department. The display language expresses a language used for expressing the name of a group such as a company and a department. Also, the display language expresses the language used for displaying access from a browser and the body of an e-mail. The time zone expresses a standard time used by a group such as a company and a department. The state expresses a state of a group such as a company and a department. The country expresses a name of a country to which a group such as a company and a department resides.

FIG. 11 is a configuration diagram of an example of user information. The user information illustrated in FIG. 11 includes, as data items, an organization ID, a user ID, a password, a user name, a display language, a time zone, and a state.

The user ID and the password are information for identifying a user (user identification information). The user ID may be a user name. Furthermore, a password is not essential. Note that the user ID and password managed by the same organization ID are unique, but may be overlapping with another user ID and password if the organization ID is different.

Furthermore, as the user ID, information for identifying an electronic medium (for example, an IC card) held by the user may be used. As the electronic medium held by the user, an IC card, a mobile phone, a tablet terminal, and an electronic book terminal may be used. As the information for identifying an electronic medium, a card ID, a serial ID, a telephone number of a mobile phone, and profile information of a terminal may be used. The information for identifying an electronic medium may be used in combination.

The user name expresses the name of the user. The display language expresses a language used for displaying the user name. Also, the display language expresses a language used for displaying access from a browser and the body of an e-mail. The time zone is a standard time used by the user. The state expresses a state of the user.

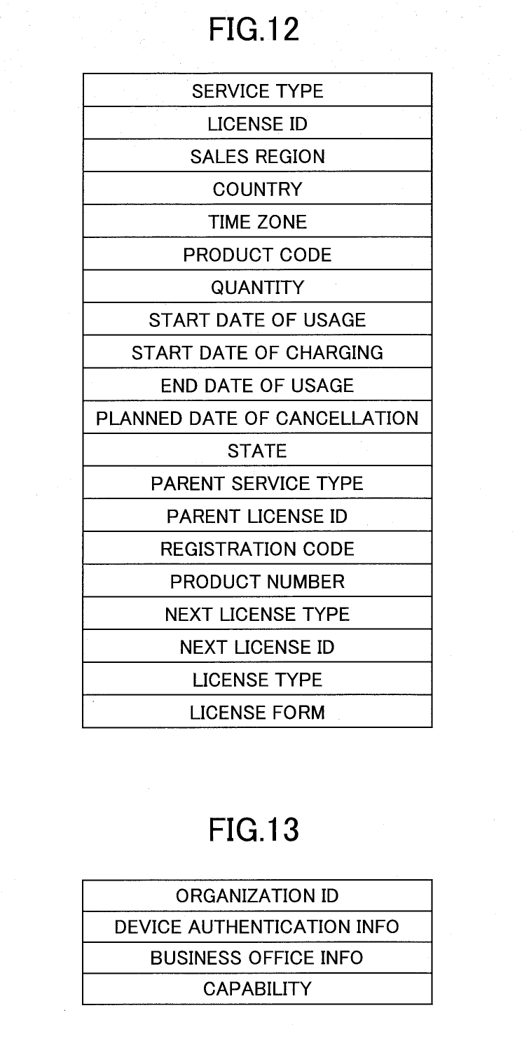

FIG. 12 is a configuration diagram of an example of license information. The license information illustrated in FIG. 12 includes, as data items, a service type, a license ID, a sales region, a country, a time zone, a product code, quantity, a start date of usage, a start date of charging, an end date of usage, a planned date of cancellation, and a state. The license information illustrated in FIG. 12 further includes, as data items, a parent service type, a parent license ID, a registration code, a product number, a next license type, a next license ID, a license type, and a license form.

The service type is information for identifying a type of a service such as portal, scan, or print. The license ID is information for identifying a license. The license ID is, for example, an organization ID for an organization license, or a service ID for a service license. The sales region is information representing a region or the like where the license is sold. The country represents the name of a country where the license is used. The time zone represents a standard time in the country where the license is used. The product code is information for identifying a product associated with the license. The quantity is information representing the number of devices in case of volume license.

The start date of usage is information representing a date when the license becomes valid. The start date of charging is information representing a date when charging of the license starts, which is the same day as the start date of usage or a later date (for example, the first day of the next month). The end date of usage is information representing a nominal license term, for example, one-year after from the start date of charging. The planned date of cancellation is information representing a date when the license is made invalid. The state is information representing a state of the license. The state of the license includes, for example, “temporary registration” that represents a state before starting usage, “registration” that represents a state in use, “cancellation” that represents an end of usage, and the like.

The parent service type is set to an organization for a service license. The parent license ID is set to an organization ID for a service license. The registration code is set for an organization license. The registration code is a code input when opening an organization. The product number is set for a service license. The product number is information for identifying a device to be licensed.

The next license type is set for a service license that has been updated. The next license type is set to the same value as the service type. The next license ID is set for a service license that has been updated. The next license ID is the service ID for a service license that has been updated.

The license type is information for identifying a type of a service license among a device license, a user license and the like. The license form is information representing whether a license is allowed to be used in combination with another service license of a different type, or to be used by itself.

For example, the license form is set to “device license only” or “device license+user license”. If the license form is set to “device license only”, use of the service is allowed by registering a service license whose license type is “device license”. Also, if the license form is set to “device license+user license”, use of the service is allowed by registering a service license whose license type is “device license” and a service license whose license type is “user license”.

An organization license and a service license have a parent-child relationship as illustrated in the license information in FIG. 12. In the license information in FIG. 12, an organization license is a parent license, and a service license is a child license. The organization license is set to the parent license ID as a parent license. Note that although a parent-child relationship between an organization license and a service license is illustrated in the license information in FIG. 12, it is possible to deal with a relationship with more than two levels such as a parent-child-grandchild relationship.

An organization license is a license that is required for using the service providing system 1100. Without an organization license, the service providing system 1100 cannot execute organization opening. By handling an organization license with the same data format as a service license, it is possible to charge on an organization itself, or to provide different service levels (speed and/or capacity) depending on charging.

The service providing system 1100 provides services to multiple organizations, and provides user management for each of the organizations independently. Also, the service providing system 1100 provides access restriction so that data cannot be referred to across the organizations. Therefore, for using the service providing system 1100, organization opening is required at the outset before using any services. A parent-child relationship of licenses is a very flexible data structure, which can represent a grouping of licenses for volume license or the like.

FIG. 13 is a configuration diagram of an example of device information. The device information illustrated in FIG. 13 includes, as data items, an organization ID, device authentication information, business office information, and capability. The device authentication information is information used for device authentication, which is performed for determining whether an office device fulfills a particular condition. The device authentication information may be an ID indicating that a particular application is installed in the office device, or a device number indicating a particular office device. The business office information expresses, for example, the business office at which the office device is installed. The capability expresses, for example, the capability of the office device.

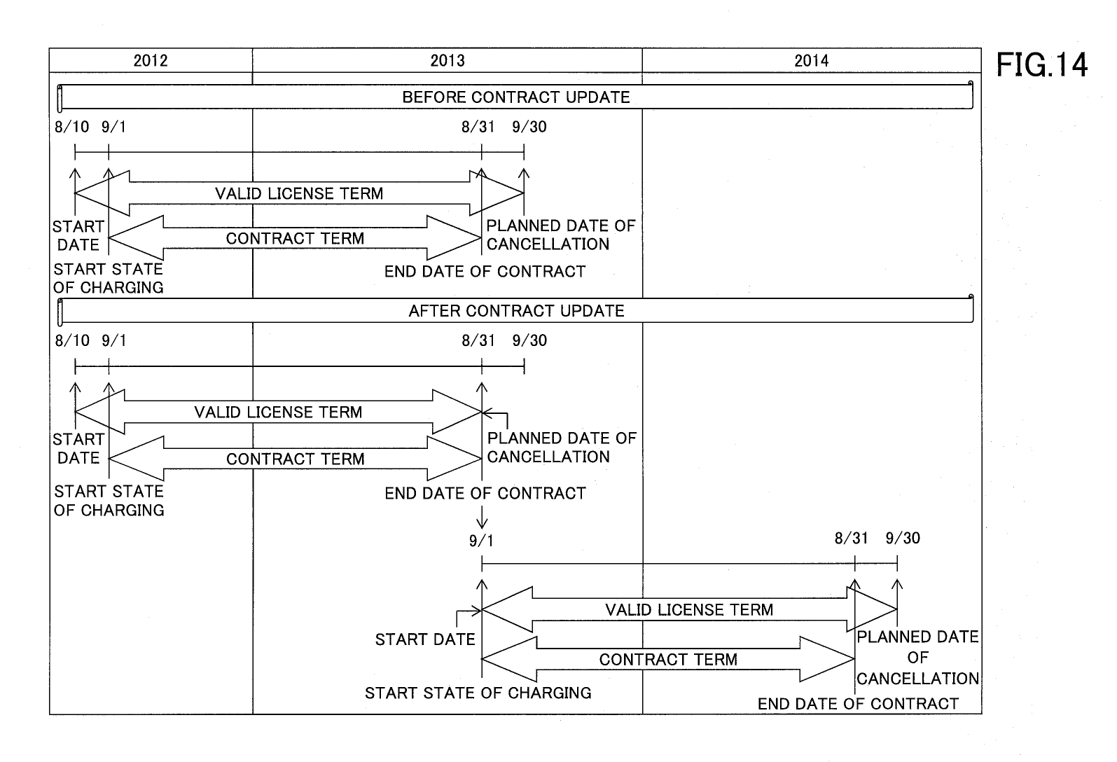

FIG. 14 is a schematic view illustrating dates included in license information. FIG. 14 illustrates start dates of usage, start dates of charging, end dates of contract (end dates of usage), planned dates of cancellation before contract (license) update and after contract (license) update, respectively.

The start date of usage (2012/8/10) is a day when the license is made valid. The start date of charging is the first day of the next month of the start date of usage (2012/9/1). Also, the end date of contract is a day one-year after from the start date of charging (2013/8/31). Also, the planned date of cancellation is the last day of the next month of the end date of contract, which includes at least an extension by days of one month from the end date of contract as a margin (2013/9/30). The end date of contract is a nominal end date of the license presented to a user. The planned date of cancellation is an actual end date of the license when the license is made invalid.

After contract update, the planned date of cancellation (2013/9/30) of a previous license is made coincident with the end date of contract (2013/8/31) of the previous license. The start date of usage and start date of charging of a next license are set to the next day of the end date of contract of the previous license (2013/9/1). The end date of contract of the next license is set to the day one-year after from the start date of charging (2014/8/31). The planned date of cancellation of the next license is set to the last day of the next month of the end date of contract, which includes at least an extension by days of one month from the end date of contract as a margin (2014/9/30).

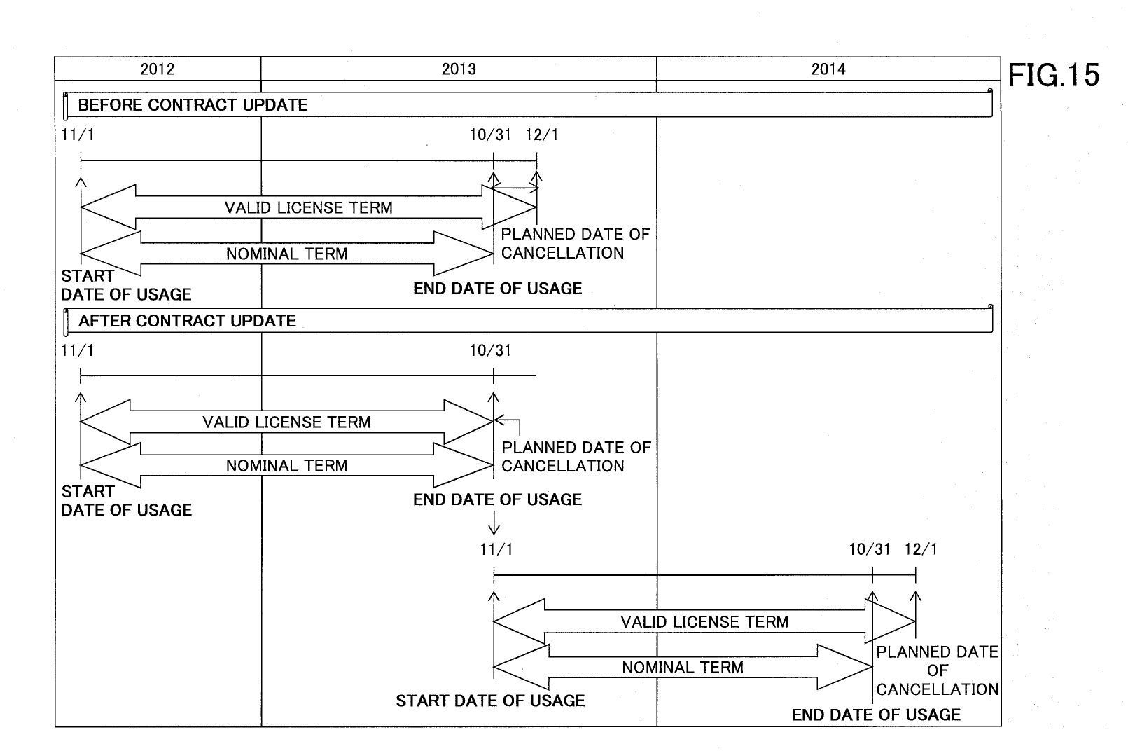

FIG. 15 is a schematic view illustrating a valid term and a nominal term of a license. FIG. 15 illustrates valid license terms and nominal terms before contract update and after contract update, respectively.

Before contract update, for example, the nominal term between the start date of usage and the end date of usage displayed on an UI is shorter than the valid license term. This is because the end date of usage corresponds to the end date of contract in FIG. 14, which is before the planned date of cancellation by one month of the margin added to the planned date of cancellation.

After contract update, the valid license term of the previous license is equivalent to, for example, the nominal term between the start date of usage and the end date of usage displayed on the UI. This is because the planned date of cancellation of the previous license is set coincident with the end date of contract of the previous license.

The start date of usage and start date of charging of the next license is the next day of the end date of contract of the previous license (2013/11/1). Similar to the previous license, for example, the nominal term of the next license between the start date of usage and the end date of usage displayed on the UI is shorter than the valid license term.

As illustrated in FIGS. 14-15, the planned date of cancellation in the license information is set by adding a margin to the end date of contract. This makes it possible to prevent a license from becoming invalid soon after the end date of contract in the service providing system 1100. Note that the planned date of cancellation is not presented to the user; hence no problems arise if it is changed after the contract update. The start date of usage and end date of usage displayed on the UI are displayed, for example, by local dates based on the time zone setting of an organization.

<Processing Details>

Note that in sequence charts described later, an actor (a human-shaped icon) represents a client application (browser) that runs on a terminal operated by a user such as a person in charge of business.

<<Issuing Organization ID>>

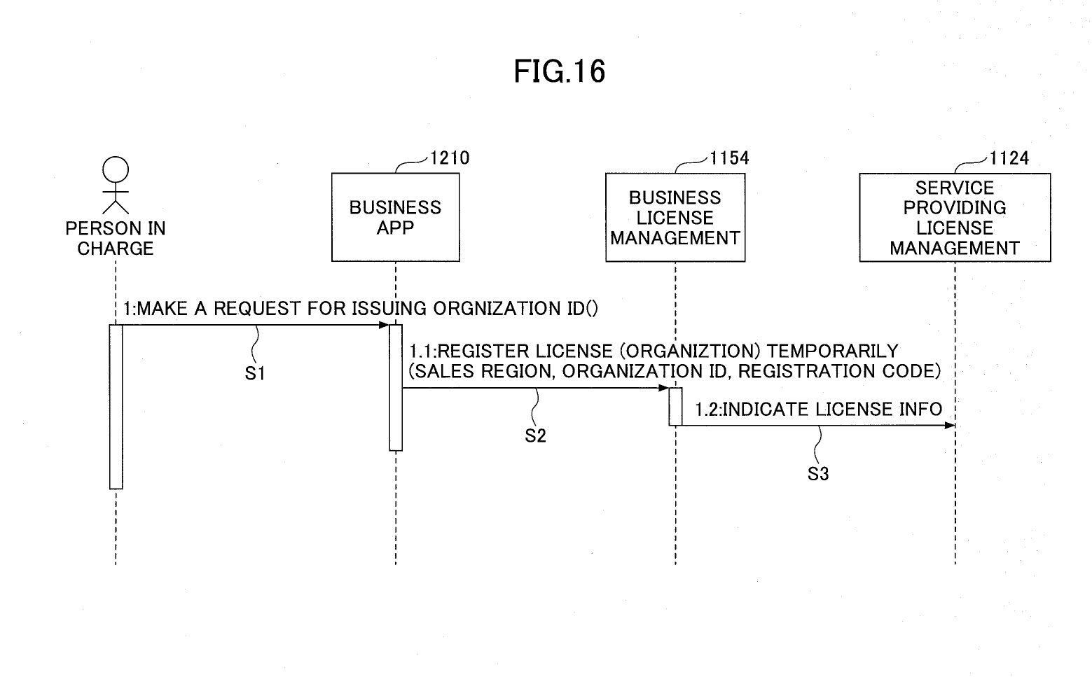

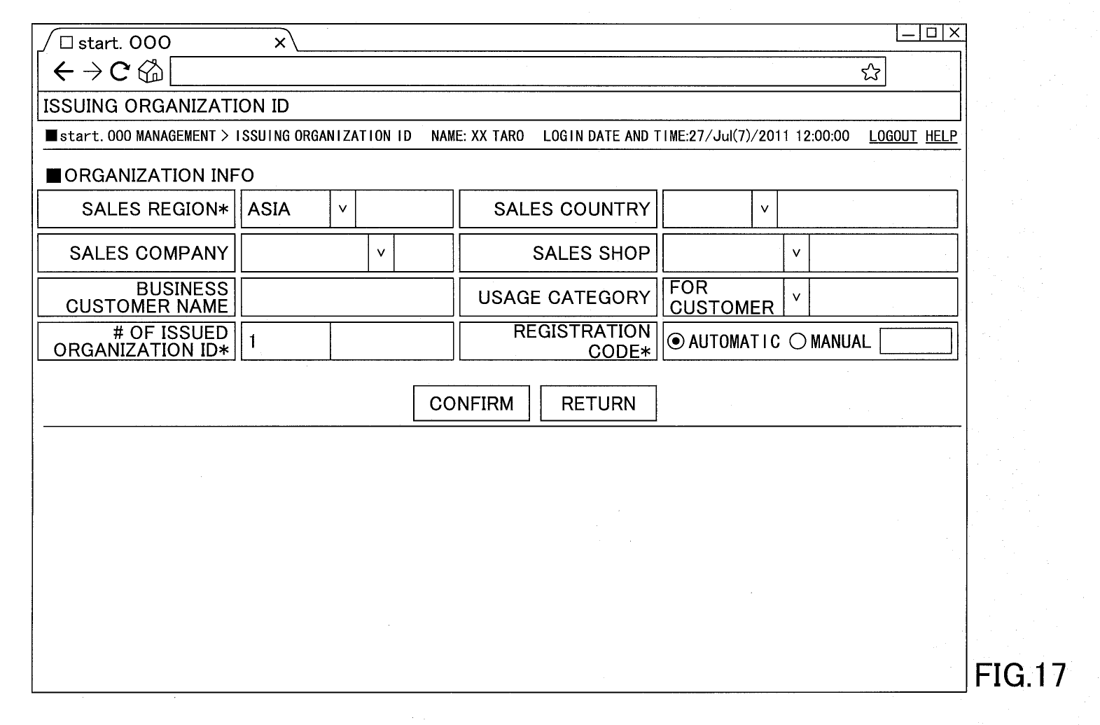

FIG. 16 is a sequence chart of an example of a procedure for issuing an organization ID. A person in charge of business operates a business terminal 1201 to display, for example, an organization ID issuance screen in FIG. 17. FIG. 17 is a schematic view illustrating an example of the organization ID issuance screen. The organization ID issuance screen in FIG. 17 is an example of a screen to have the person in charge of business input information required for issuing an organization ID.

The organization ID issuance screen in FIG. 17 includes an entry field for specifying a sales region where the person in charge of business sells licenses. The organization ID issuance screen in FIG. 17 illustrates an example in which “ASIA” is specified as the sales region.

At Step S1, the person in charge of business operates the business terminal 1201, specifies the sales region to the business application 1210, and makes a request for issuing an organization ID. The business application 1210 issues an organization ID and a registration code. At Step S2, the business application 1210 temporarily registers the sales region, organization ID, and registration code into the business license management unit 1154. At Step S3, the business license management unit 1154 indicates the temporarily registered organization ID and registration code to the service providing license management unit 1124 corresponding to the sales region. The service providing license management unit 1124 corresponding to the sales region stores the indicated organization ID and registration code into the license information storage unit 1144.

Having executed the sequence in FIG. 16, an administrator purchases an organization license for using the service providing system 1100 from, for example, a sales company, to obtain the organization ID and registration code from the sales company.

<<Opening Organization>>

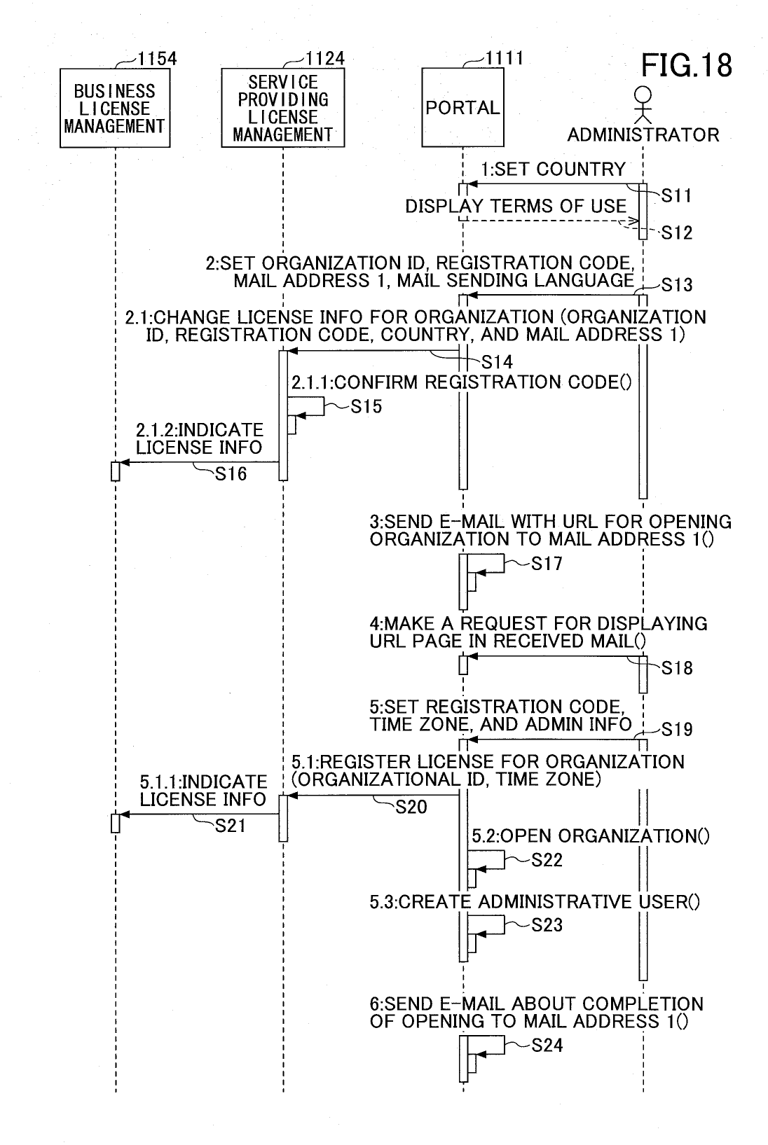

FIG. 18 is a sequence chart of an example of a procedure for opening an organization. An administrator operates a user terminal 1202, inputs a URL of an organization opening screen as an access destination, or selects the URL from bookmarks, for example, to receive an organization opening screen from the portal service application 1111.

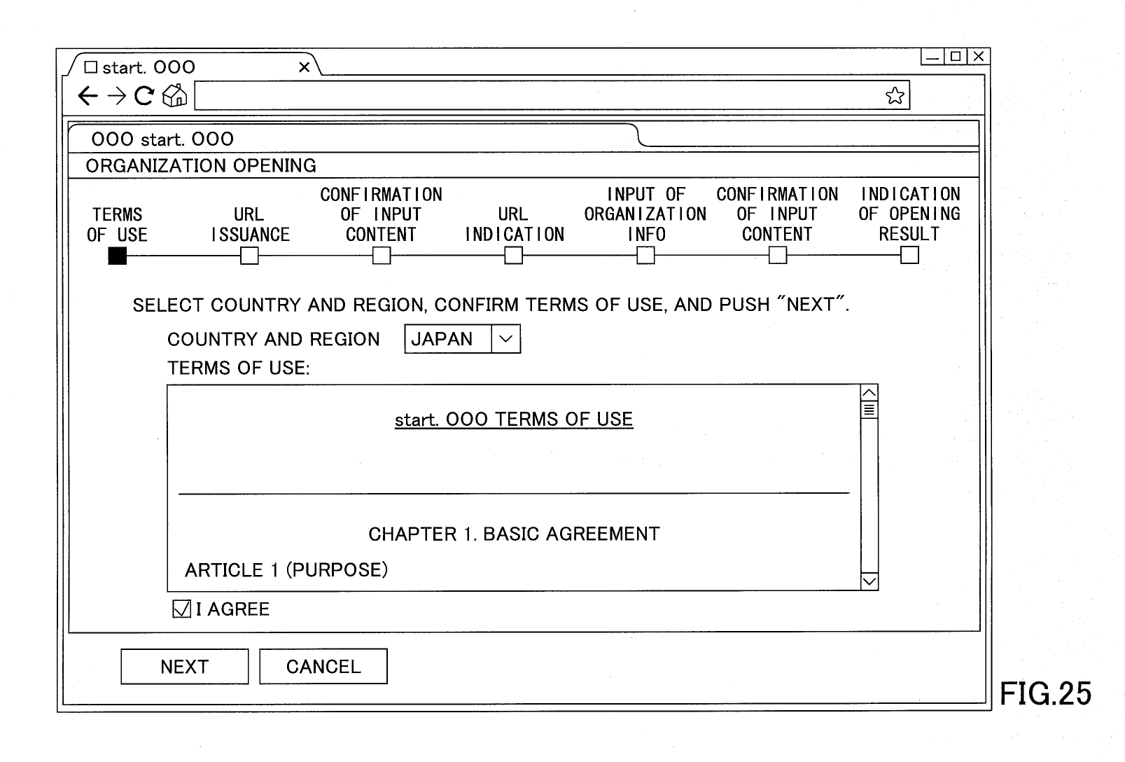

At Step S11, the administrator operates the user terminal 1202, and sets a country in the organization opening screen. Note that a country that can be set on the organization opening screen may be restricted, for example, to countries corresponding to the sales region. At Step S12, the portal service application 1111 displays terms of use of the country set by the administrator on a terms-of-use screen as illustrated in FIG. 25. FIG. 25 is a schematic view illustrating an example of the terms-of-use screen. FIG. 25 illustrates an example in which “JAPAN” is set as a country on the organization opening screen.

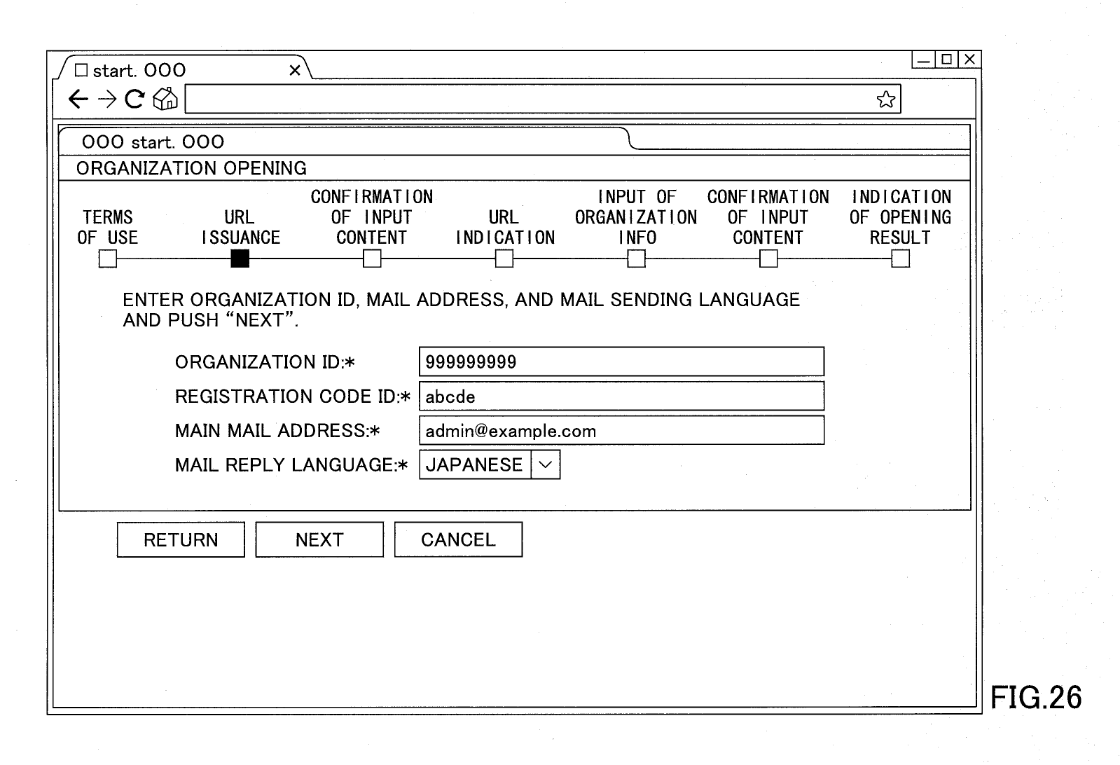

Having confirmed the terms of use, the administrator operates the user terminal 1202 to display a URL issuance screen as illustrated in FIG. 26. FIG. 26 is a schematic view illustrating an example of the URL issuance screen. The administrator operates the user terminal 1202, and sets the organization ID, registration code, e-mail address, and mail sending language obtained from the sales company.

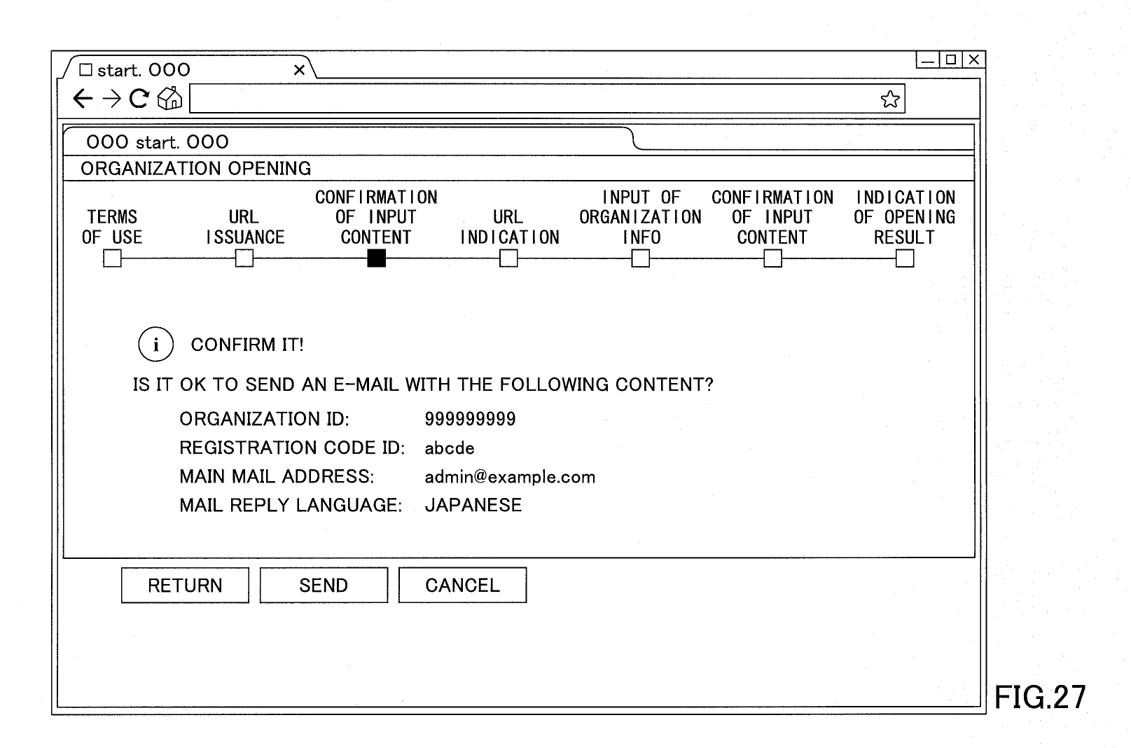

Having the setting done on the URL issuance screen, the administrator operates the user terminal 1202 to display an input content confirmation screen as illustrated in FIG. 27. FIG. 27 is a schematic view illustrating an example of the input content confirmation screen. Having confirmed the content input on the URL issuance screen, the administrator pushes down a sending button. At Step S13, when the administrator pushes down the sending button, the portal service application 1111 receives the content input by the administrator.

At Step S14, the portal service application 1111 makes a request for changing the license information of the organization license to the service providing license management unit 1124. The request made at Step S14 includes the organization ID, registration code, country and e-mail address.

At Step S15, the service providing license management unit 1124 confirms whether the organization ID and registration code included in the request at Step S14 are stored in the license information storage unit 1144. At Step S15, it is confirmed whether the registration code is correct that has been input by the administrator.

If the organization ID and registration code included in the request at Step S14 are stored in the license information storage unit 1144, the service providing license management unit 1124 indicates the changed license information to the business license management unit 1154 at Step S16. The license information indicated at Step S16 has been added with the country and e-mail address. The business license management unit 1154 changes the content of the license DB 1207 with the license information indicated at Step S16. Note that a success or a failure of a change of the license information is indicated to the portal service application 1111 from the business license management unit 1154 via the service providing license management unit 1124.

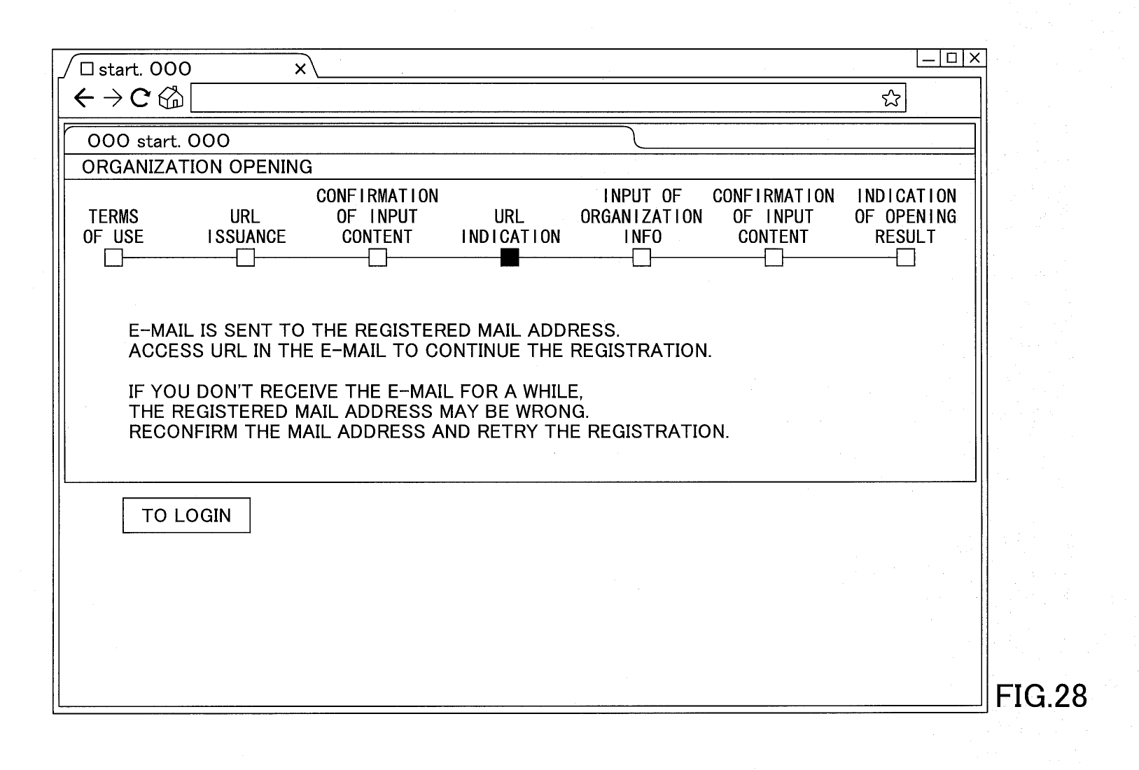

On the other hand, the portal service application 1111 having the sending button pushed down by the administrator displays a URL indication screen on the user terminal 1202 as illustrated in FIG. 28. FIG. 28 is a schematic view illustrating an example of the URL indication screen. The URL indication screen in FIG. 28 includes a message stating that an e-mail has been sent to the e-mail address set on the URL issuance screen in FIG. 26, and a message requesting to access an URL described in the e-mail to continue the organization opening.

At Step S17, the portal service application 1111 sends an e-mail describing the URL for organization opening to the e-mail address set on the URL issuance screen in FIG. 26. If the e-mail address set on the URL issuance screen in FIG. 26 is not correct, the administrator cannot receive the e-mail, which makes the administrator correct the wrong setting of the e-mail address.

Note that, if organization opening cannot be continued due to an error, the portal service application 1111 sends an e-mail including a message stating that the organization opening failed to the e-mail address set on the URL issuance screen in FIG. 26. Organization opening may fail if the organization ID and registration code included in the request at Step S14 are not stored in the license information storage unit 1144, or if the organization ID and registration code have already been in use. Note that the e-mail including a message stating that the organization opening failed does not include content with which the error case can be identified to avoid giving a hint to a malicious user, and is always sent with the same content.

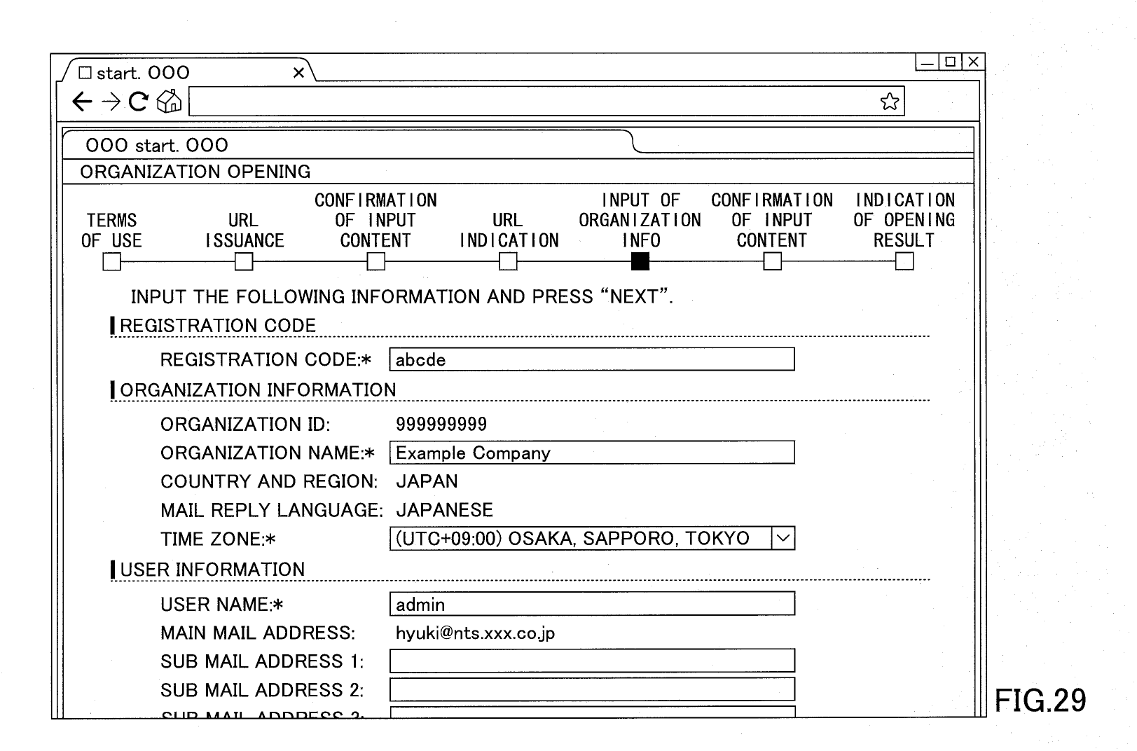

At Step S18, the administrator operates the user terminal 1202, and makes a request for displaying a page of the URL for organization opening described in the e-mail to the portal service application 1111. The user terminal 1202 displays an organization information input screen as illustrated in FIG. 29. FIG. 29 is a schematic view illustrating an example of the organization information input screen.

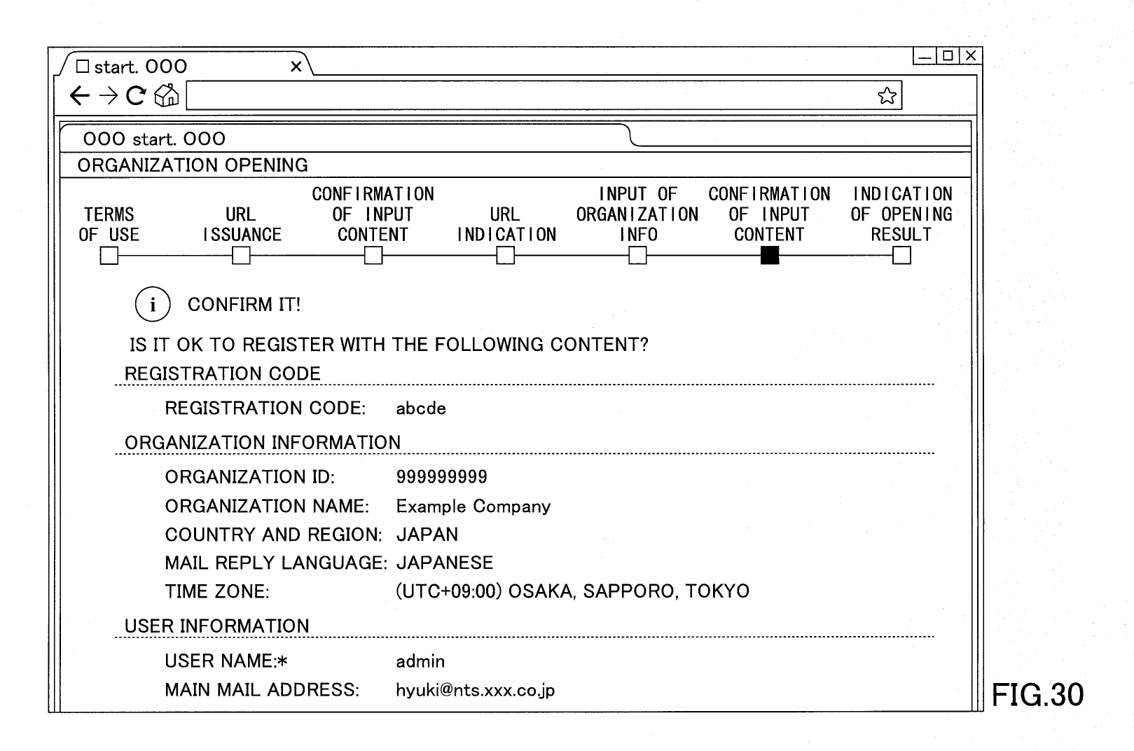

The administrator operates the user terminal 1202, and sets the registration code, organization information, administrator information (user information) obtained from the sales company. Having the setting done on the organization information input screen, the administrator operates the user terminal 1202 to display an input content confirmation screen as illustrated in FIG. 30. FIG. 30 is a schematic view illustrating an example of the input content confirmation screen. Having confirmed the content input on the organization information input screen, the administrator pushes down a registration button.

When the administrator pushes down the registration button, the portal service application 1111 receives the content input by the administrator at Step S19. At Step S20, the portal service application 1111 makes a request for registering the license information of the organization license to the service providing license management unit 1124. The request made at Step S20 includes the organization ID and time zone.

At Step S21, the service providing license management unit 1124 indicates the changed license information to the business license management unit 1154. The license information indicated at Step S21 has been added with the time zone and start date of usage. The business license management unit 1154 changes the content of the license DB 1207 with the license information indicated at Step S21. Note that a success or a failure of a registration of the license information is indicated to the portal service application 1111 from the business license management unit 1154 via the service providing license management unit 1124.

At Step S22, the portal service application 1111 opens the organization by making a request to the organization management unit 1122 for storing the organization information into the organization information storage unit 1142, and for generating a portal site for the organization.

At Step S23, the portal service application 1111 makes a request to the user management unit 1123 for storing user information of the administrator into the user information storage unit 1143. At Step S24, the portal service application 1111 sends an e-mail stating that the organization opening is completed to the e-mail address set on the URL issuance screen in FIG. 26.

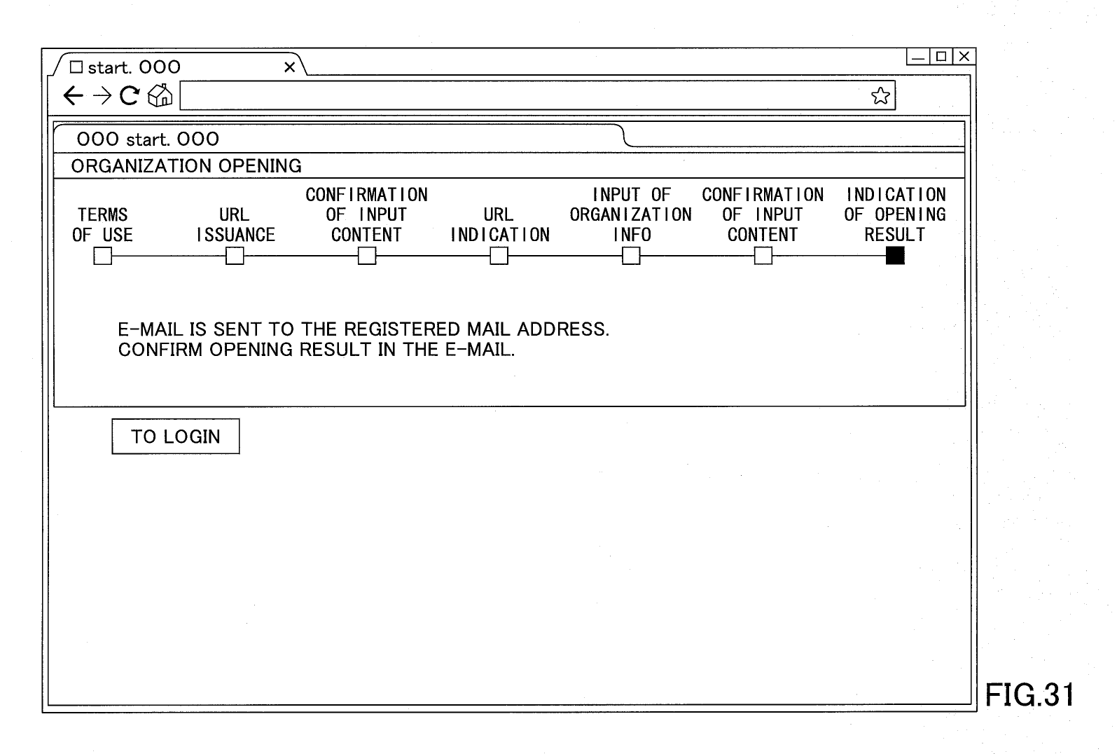

Also, the portal service application 1111 has the user terminal 1202 display an opening result indication screen, for example, as illustrated in FIG. 31. FIG. 31 is a schematic view illustrating an example of the opening result indication screen. The opening result indication screen in FIG. 31 includes a message stating that an e-mail about the opening result has been sent to the e-mail address set on the URL issuance screen in FIG. 26.

<<Issuing Service ID>>

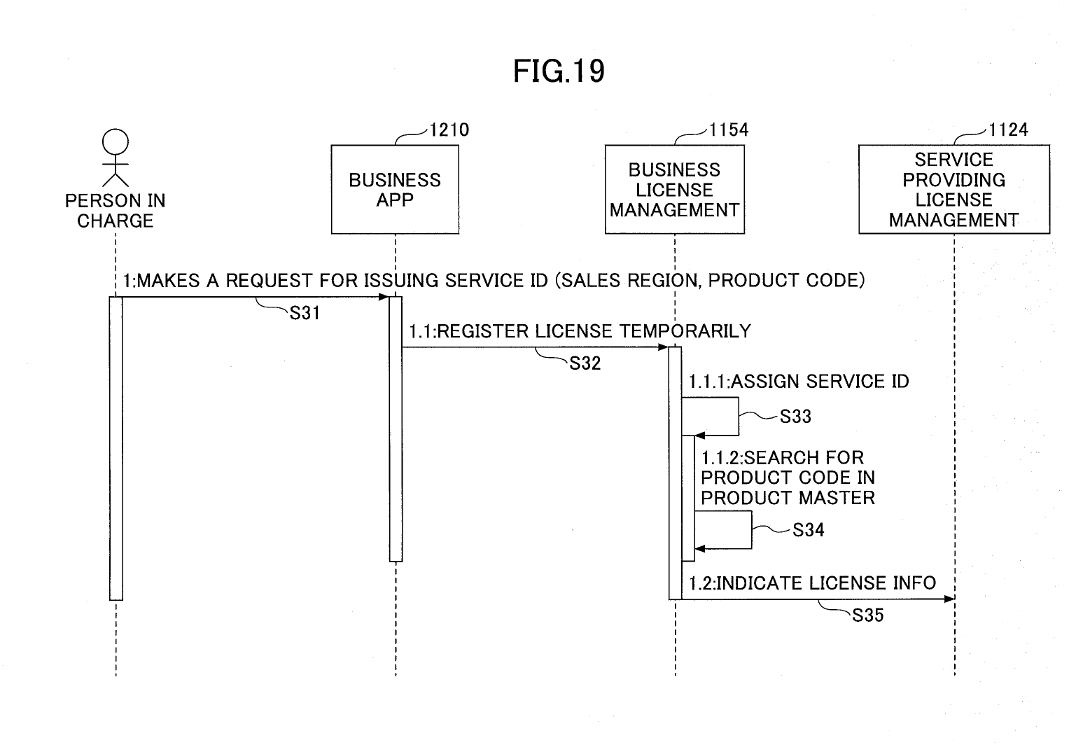

FIG. 19 is a sequence chart of an example of a procedure for issuing a service ID. A person in charge of business operates the business terminal 1201 to display a service ID issuance screen (not shown). The service ID issuance screen is a screen for having the person in charge of business input required information for issuing a service ID. The person in charge of business specifies a sales region where licenses are sold on the service ID issuance screen.

At Step S31, the person in charge of business operates the business terminal 1201, selects a sales region and a product code, and makes a request for issuing a service ID to the business application 1210. At Step S32, the business application 1210 specifies the sales region and product code, and temporarily registers a license into the business license management unit 1154. At Step S33, the business license management unit 1154 assigns a service ID. The business license management unit 1154 stores the assigned service ID into the license DB 1207. At Step S34, the business license management unit 1154 searches for the product code in a product master to store the service type, sales region, product code, and quantity into the license DB 1207.

At Step S35, the business license management unit 1154 indicates the license information including the assigned service ID to the service providing license management unit 1124 corresponding to the sales region. The service providing license management unit 1124 corresponding to the sales region stores the indicated service ID into the license information storage unit 1144.

Having executed the sequence in FIG. 19, an administrator purchases a service license for using, for example, the scan service application 1112 or the like from a sales company to obtain the service ID from the sales company.

<<Registering Service ID>>

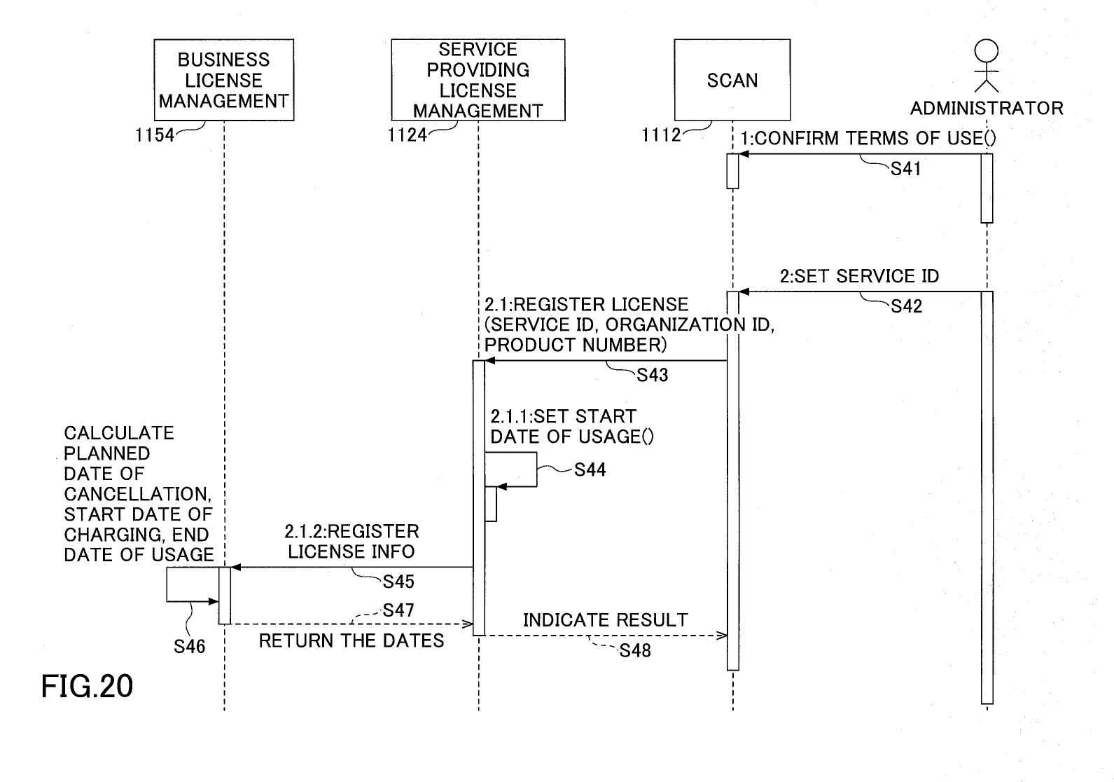

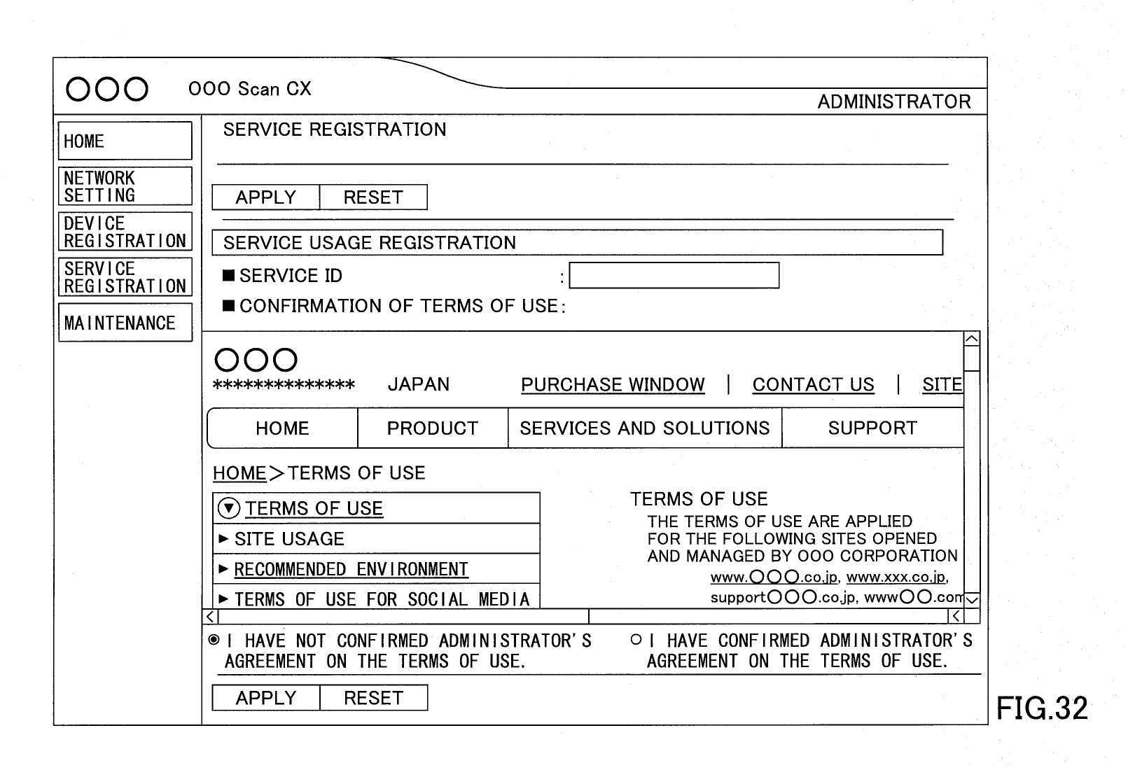

FIG. 20 is a sequence chart of an example of a procedure for registering a service ID. The administrator operates the MFP 1203 to display a service registration screen as illustrated in FIG. 32. FIG. 32 is a schematic view illustrating an example of the service registration screen. Note that service registration screen can be implemented with a Web UI provided by an SDK application that runs on the MFP 1203. At Step S41, the administrator confirms terms of use displayed on the service registration screen.

At Step S42, the administrator operates the MFP 1203, and sets the service ID obtained from the sales company on the service registration screen. Having the setting done on the service registration screen, the administrator operates the MFP 1203, and pushes down an application button.

When the administrator pushes down the application button, the scan service application 1112 makes a request for registering the license information of the service license to the service providing license management unit 1124 corresponding to the sales region at Step S43. Note that the request made at Step S43 includes the service ID, organization ID, and product number of the MFP 1203.

At Step S44, the service providing license management unit 1124 identifies the license information stored in the license information storage unit 1144 based on the service ID included in the request at Step S43. The service providing license management unit 1124 sets the organization ID and product number of the MFP 1203 into the identified license information. At Step S44, the service ID to be registered, the organization ID of the organization of the administrator, and the product number of the MFP 1203 in use are associated with each other and stored. The service providing license management unit 1124 sets current date and time as the start date of usage described earlier into the identified license information.

At Step S45, the service providing license management unit 1124 makes a request for registering the license information of the service license to the business license management unit 1154. At Step S46, the business license management unit 1154 calculates a planned date of cancellation, a start date of charging, and an end date of usage with respect to the start date of usage as a reference. At Step S47, the business license management unit 1154 returns the calculated planned date of cancellation, start date of charging and end date of usage to the service providing license management unit 1124. The service providing license management unit 1124 preserves the planned date of cancellation, start date of charging and end date of usage into the license DB 1209.

Next, at Step S48, a success or a failure of the registration of the license information is indicated to scan service application 1112 from the service providing license management unit 1124. If the registration of the service ID failed, the scan service application 1112 has the MFP 1203 display a message stating that the registration of the service ID failed. A registration of a service ID may fail if the service ID set at Step S42 is not stored in the license information storage unit 1144, or if the service ID has already been in use.

Note that when displaying a message stating that the registration of the service ID failed, the message does not include content with which the error case can be identified to avoid giving a hint to a malicious user, and is always displayed with the same content. Also, according to the sequence chart in FIG. 20, the service ID and the product number of the MFP 1203 can be associated with each other to be stored by inputting the service ID from the UI of the scan service application 1112 running on the MFP 1203.

<<Updating Contracted Service>>

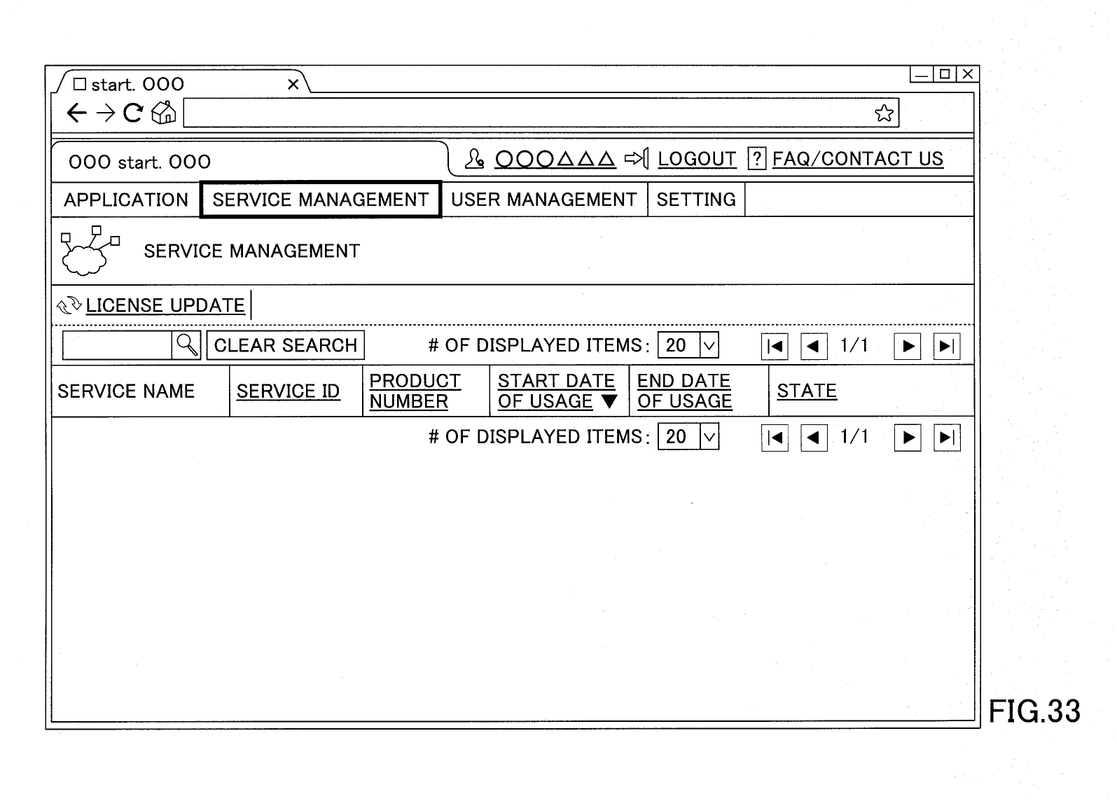

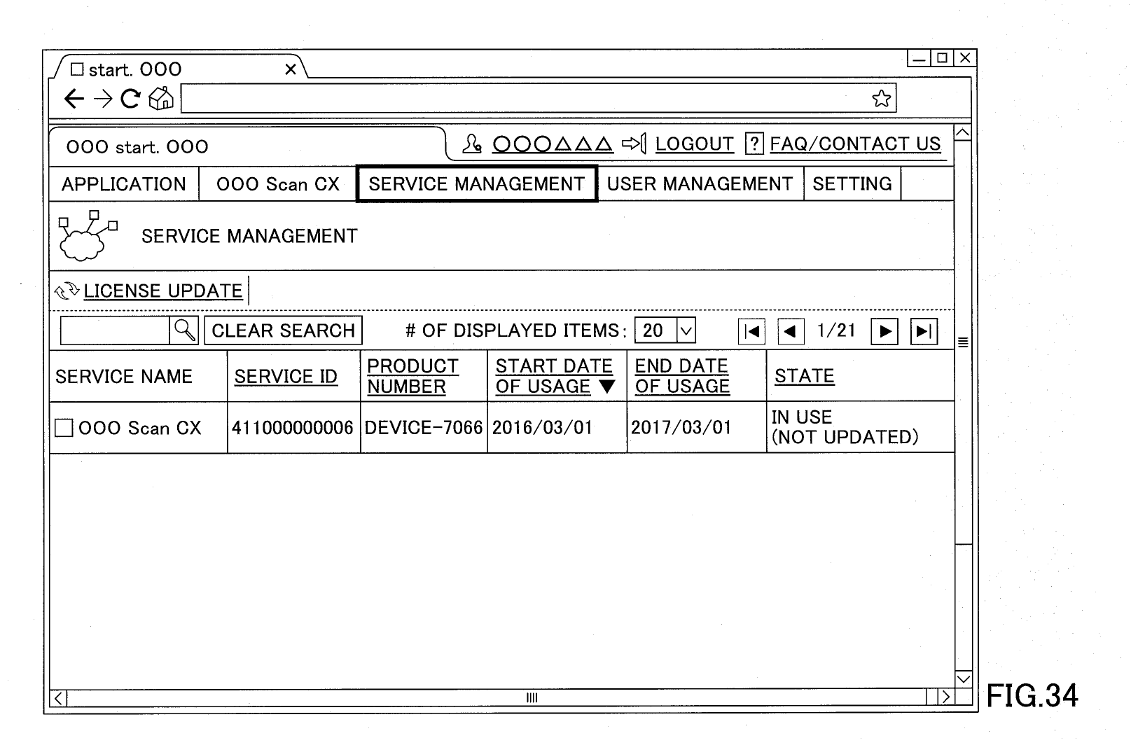

The administrator operates the user terminal 1202 and accesses the portal service application 1111 to receive a service management screen as illustrated in FIG. 33 or FIG. 34 from t portal service application 1111. FIG. 33 is a schematic view illustrating an example of the service management screen before service registration. FIG. 34 is a schematic view illustrating an example of the service management screen after service registration.

The service management screen in FIG. 33 illustrates a state where no service license is registered. The service management screen in FIG. 34 illustrates that one service license is displayed, which has been registered from the MFP 1203. Note that the service license displayed on the service management screen in FIG. 34 has a state of “IN USE (NOT UPDATED)”.

The service license displayed on the service management screen in FIG. 34 is a service license of the organization of the administrator who logs in the portal service application 1111. Note that the service license of the organization of the administrator who logs in can be searched with a parent license ID of the license information in FIG. 12. Note that a state of the service license on the service management screen in FIG. 34 is displayed as either of “IN USE (NOT UPDATED)” or “IN USE (UPDATED)”, depending whether a next license ID is registered.

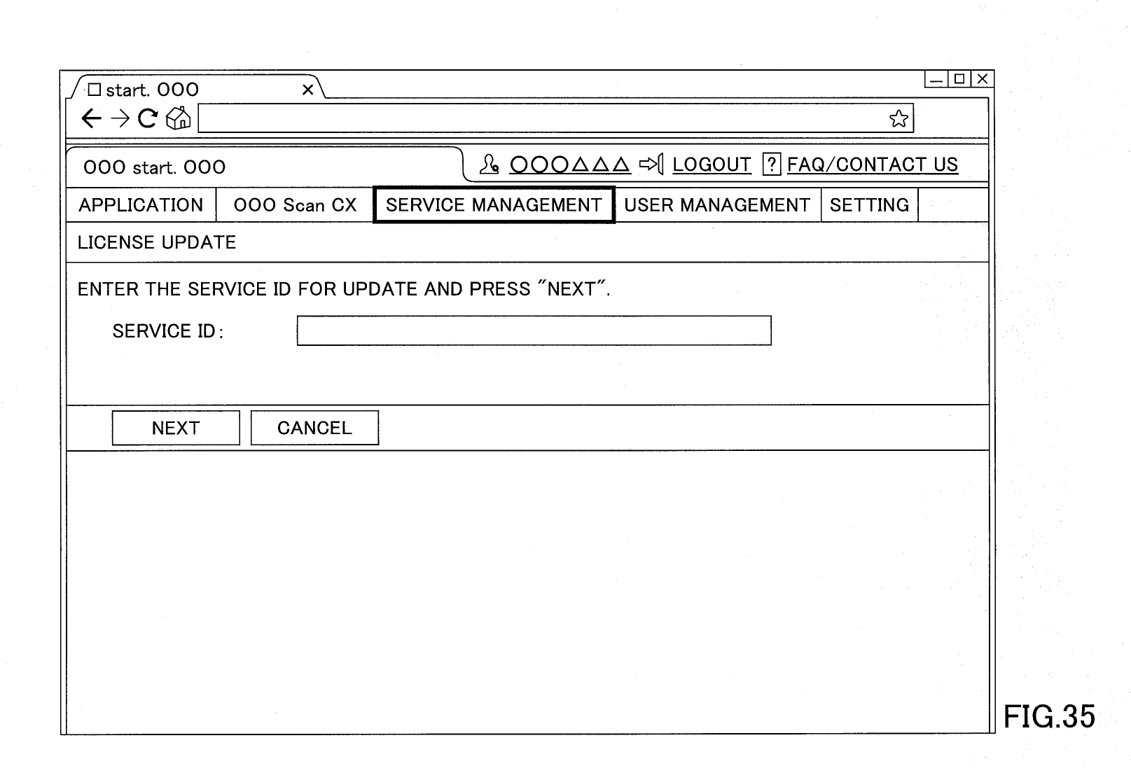

The administrator operates the user terminal 1202 to display a service ID input screen as illustrated in FIG. 35 by clicking, for example, a license update link on the service management screen in FIG. 34. FIG. 35 is a schematic view illustrating an example of the service ID input screen for license update. The administrator can start updating a contracted service on the service ID input screen illustrated in FIG. 35.

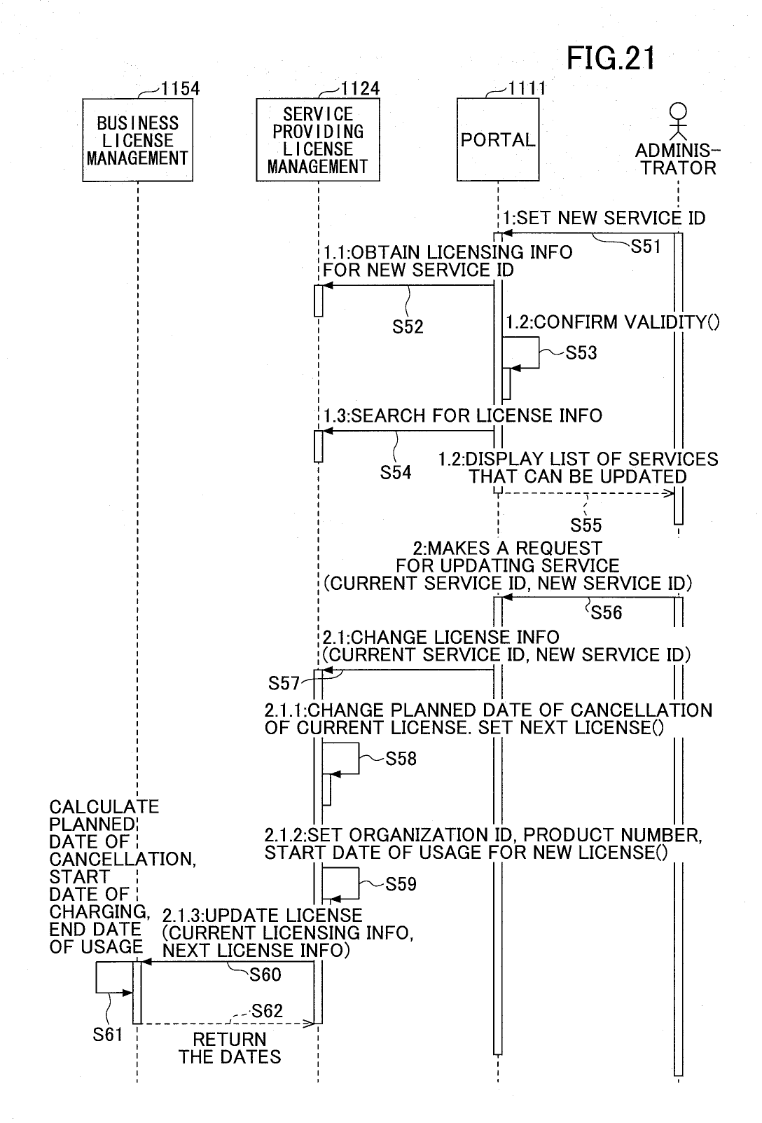

FIG. 21 is a sequence chart of an example of a procedure for updating a contracted service. Note that a service license of a contracted service to be updated in the sequence chart in FIG. 21 has a state of “IN USE (NOT UPDATED)”.

At Step S51, the administrator operates the user terminal 1202 and sets a service ID (new service ID) used for updating from the service ID input screen. At Step S52, the portal service application 1111 obtains license information having the license ID set to the new service ID specified on the service ID input screen from the service providing license management unit 1124.

At Step S53, the portal service application 1111 confirms validity of the new service ID set at Step S51 based on the license information obtained at Step S52. Note that if the new service ID has been input incorrectly, the portal service application 1111 displays a message stating that the input is not correct. Input of a new service ID may not be correct if the new service ID is not stored in the license information storage unit 1144, or if it has already been in use. Note that when displaying a message stating that input of a new service ID is not correct, the message does not include content with which the error case can be identified to avoid giving a hint to a malicious user, and is always displayed with the same content.

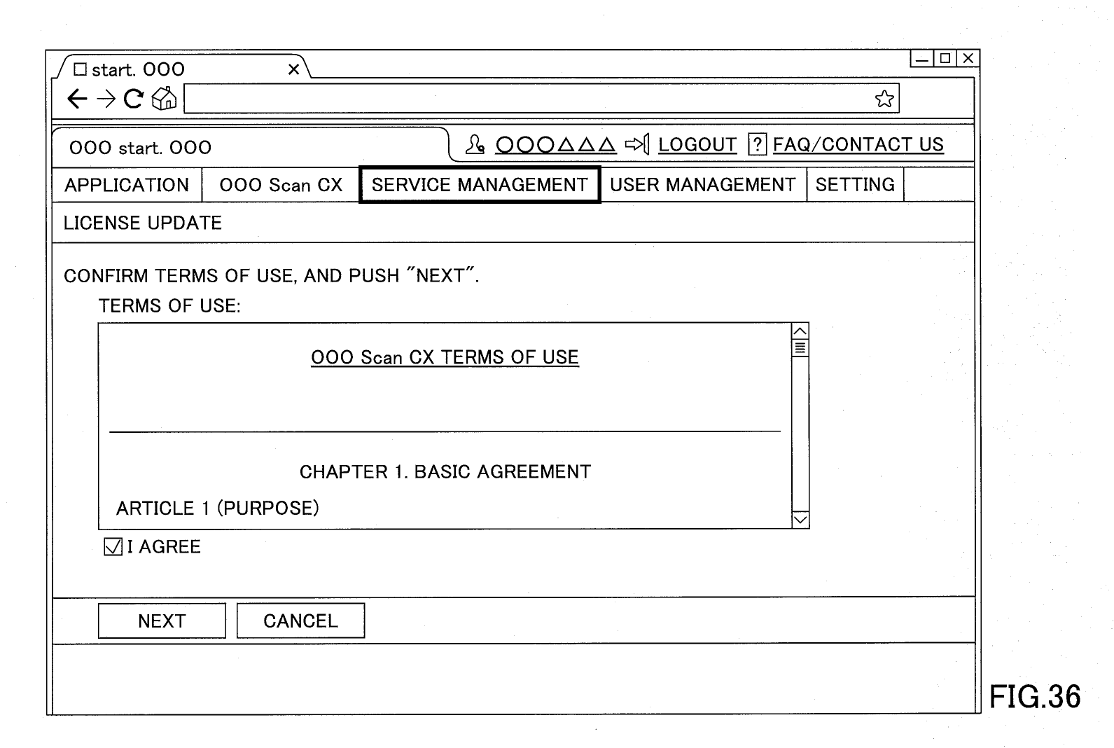

If the new service ID set at Step S53 is valid, the portal service application 1111 displays a terms-of-use screen, for example, as illustrated in FIG. 36. FIG. 36 is a schematic view illustrating an example of the terms-of-use screen for license update. After the administrator has confirmed the terms of use, the portal service application 1111 searches for license information that has the same parent service ID and service type as the license information obtained at Step S52.

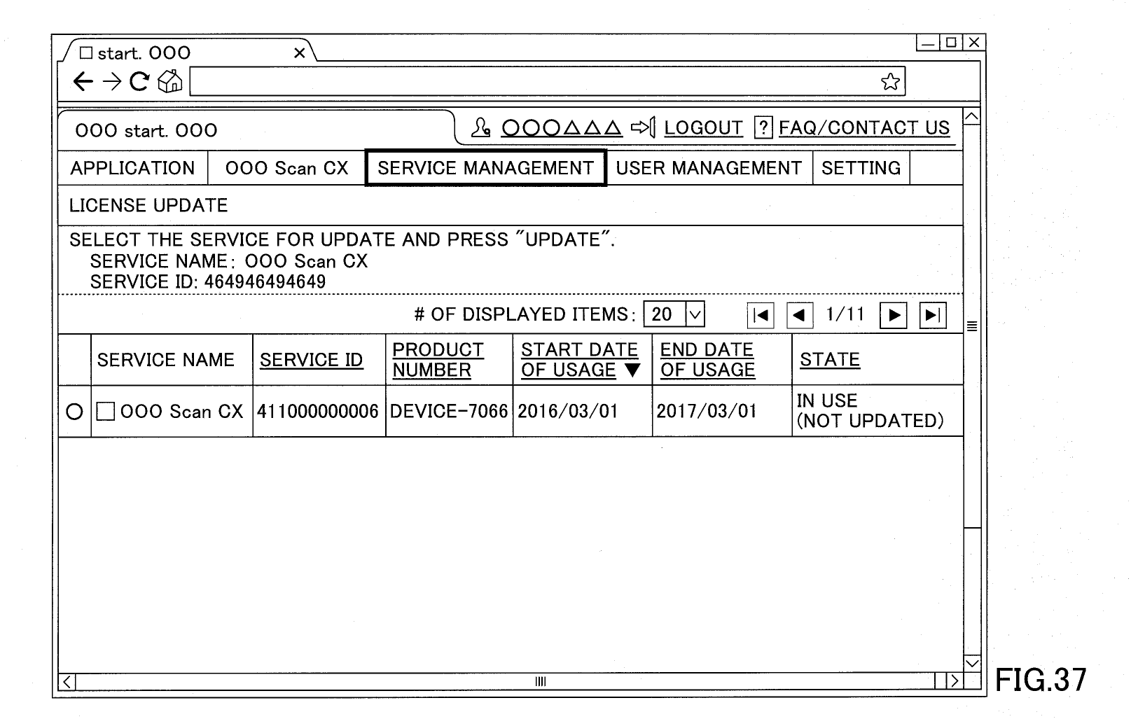

At Step S55, the portal service application 1111 displays license information of services that can be updated, in other words, a list of service licenses whose states are set to “IN USE (NOT UPDATED)” as illustrated in FIG. 37, based on the license information searched for at Step S54. FIG. 37 is a schematic view illustrating an example of a service selection screen for license update.

At Step S56, an operator operates the user terminal 1202, selects a service ID to be updated on the service selection screen in FIG. 37, and makes a request for updating the service to the portal service application 1111. The request made at Step S56 includes the service ID (current service ID) to be updated and a service ID (new service ID) used for the update.

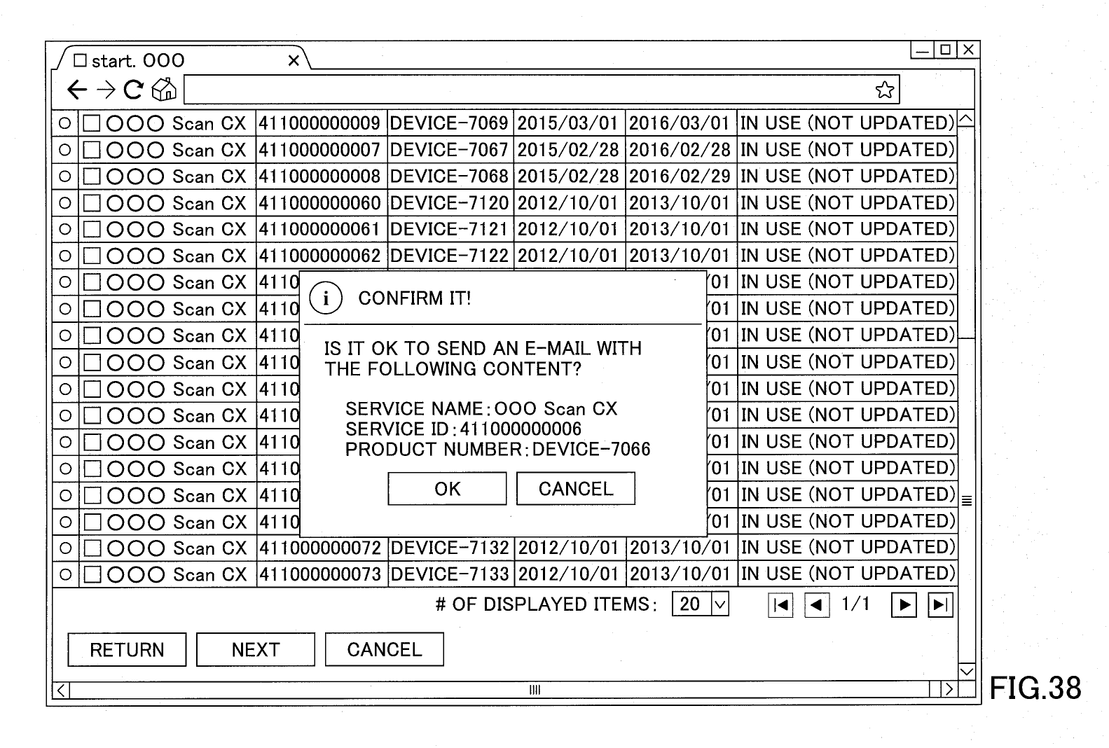

A confirmation screen as illustrated in FIG. 38 is displayed on the user terminal 1202. FIG. 38 is a schematic view illustrating an example of the confirmation screen for license update. Having confirmed the content of the confirmation screen in FIG. 38, the administrator pushes down an OK button. When the administrator pushes down the OK button, the portal service application 1111 makes a request for changing the license information to the service providing license management unit 1124 at Step S57. The request made at Step S57 includes the current service ID and new service ID.

Proceeding to Step S58, the service providing license management unit 1124 changes the planned date of cancellation of the license information in which the license ID has been set to the current service ID (current license), to the same date as the end date of usage. Also, the service providing license management unit 1124 sets the new service ID to next license ID of the current license.

Next, proceeding to Step S59, the service providing license management unit 1124 sets the organization ID, product number, start date of usage (current date and time) of the license information in which the license ID is set to the new service ID (new license), based on the current license. Then, at Step S60, the service providing license management unit 1124 makes a request for updating the license information of the service license to the business license management unit 1154.

At Step S61, the business license management unit 1154 calculates a planned date of cancellation, a start date of charging, and an end date of usage with respect to the start date of usage as a reference. At Step S62, the business license management unit 1154 returns the calculated planned date of cancellation, start date of charging, and end date of usage to the service providing license management unit 1124. The service providing license management unit 1124 preserves the planned date of cancellation, start date of charging, and end date of usage into the license DB 1209.

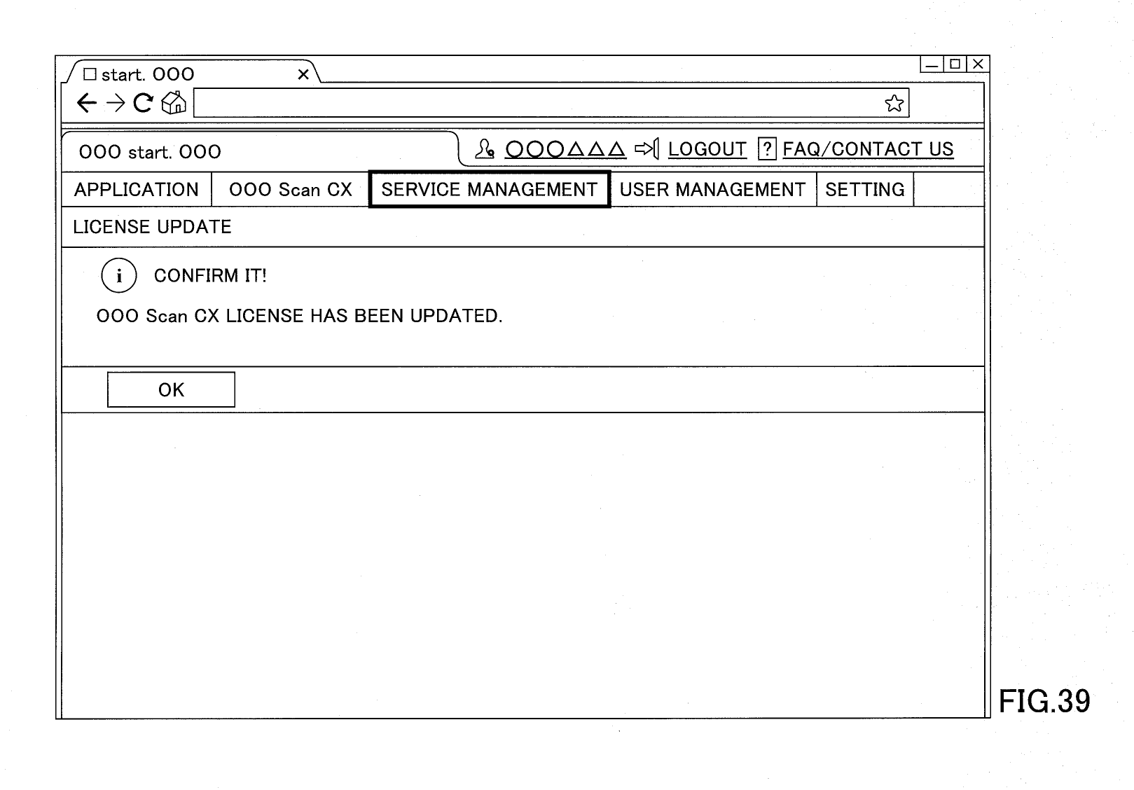

Note that a completion of an update of a contracted service can be indicated from the service providing license management unit 1124 to the portal service application 1111. Upon a completion of an update of a contracted service, the portal service application 1111 has the user terminal 1202 display a closing screen for license update as illustrated in FIG. 39. FIG. 39 is a schematic view illustrating an example of the closing screen for license update.

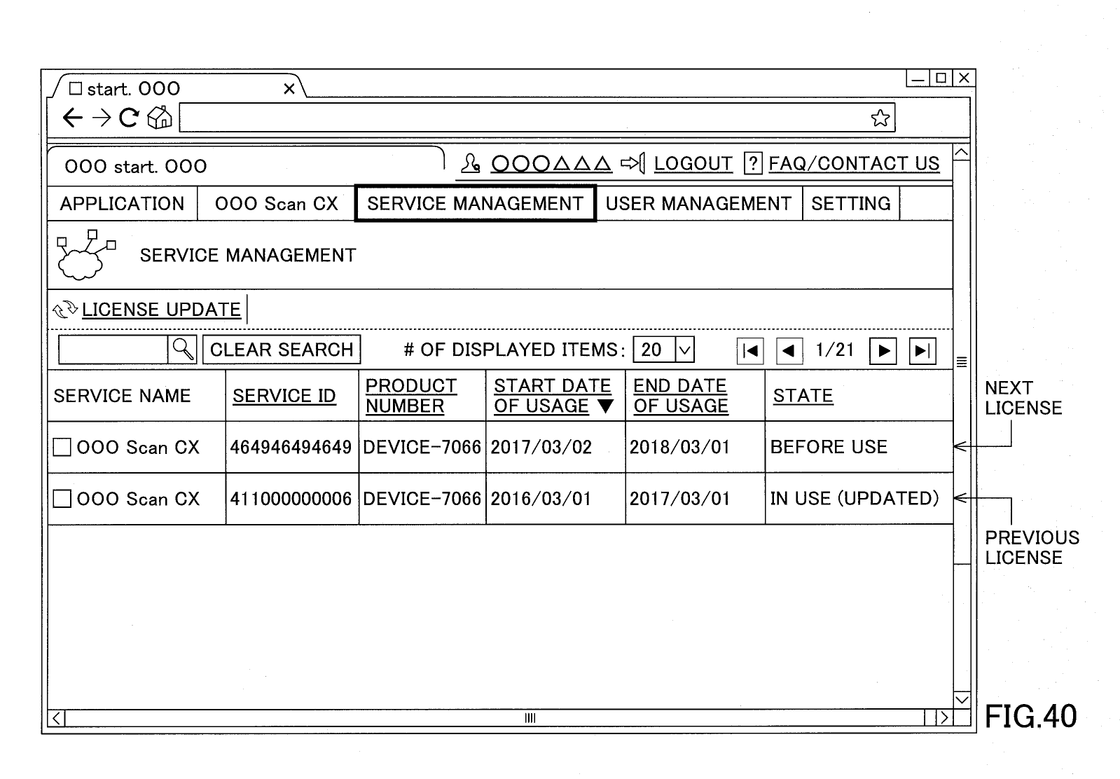

After the update of the contracted service has been completed, the service management screen illustrated in FIG. 34 changes to a service management screen illustrated in FIG. 40. FIG. 40 is a schematic view illustrating an example of the service management screen after license update. On the service management screen in FIG. 40, the state of the current license has changed into “IN USE (UPDATED)” from “IN USE (NOT UPDATED)” in FIG. 34. Also, on the service management screen in FIG. 40, the new license of the service license before usage is added.

<<Canceling Organization ID>>

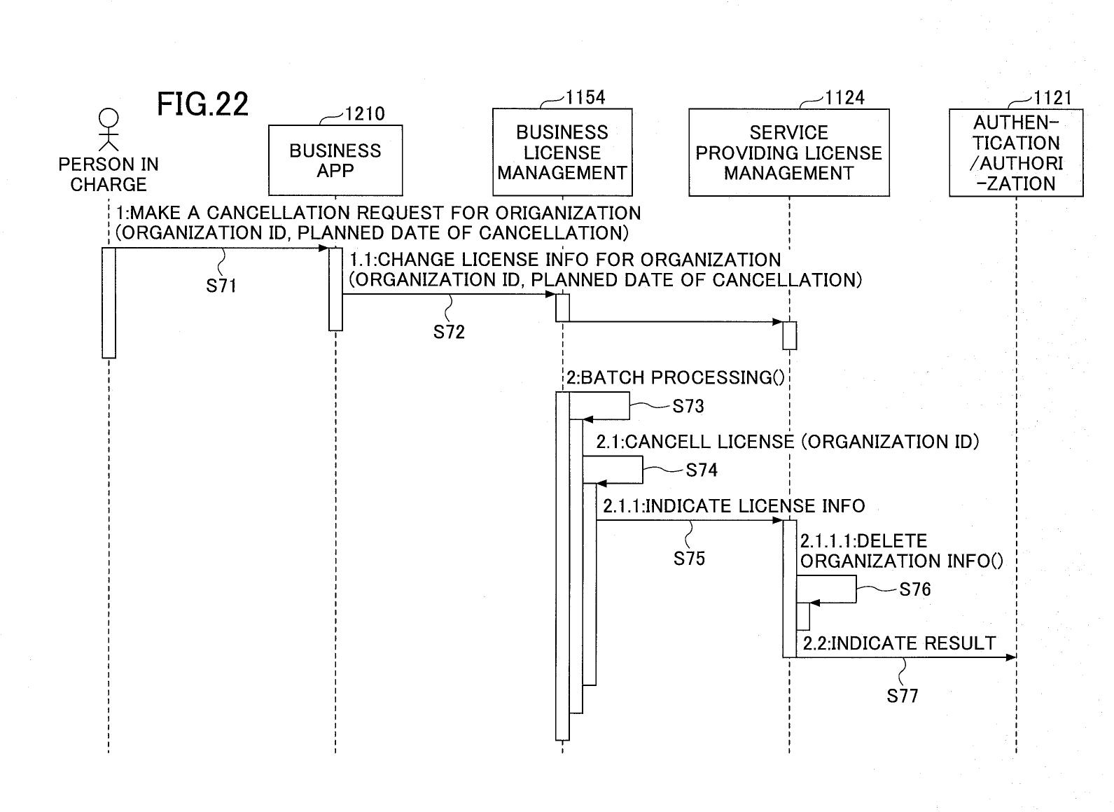

FIG. 22 is a sequence chart of an example of a procedure for canceling an organization. At Step S71, a person in charge of business operates the business terminal 1201, and makes a request for canceling an organization ID to the business application 1210. The request made at Step S71 includes the organization ID and planned date of cancellation.

At Step S72, the business application 1210 makes a request for changing the license information of the organization license. The request made at Step S72 includes the organization ID and planned date of cancellation. After the execution of Step S72, the same request for changing the license information as at Step S72 is sent from the business license management unit 1154 to the service providing license management unit 1124 corresponding to the sales region of the organization ID to be canceled. When the planned date of cancellation comes, the business license management unit 1154 starts batch processing at Step S73. At Step S74, the business license management unit 1154 changes the state of the license information of the organization license and service license corresponding to the organization ID into “CANCELED”.

At Step S75, the business license management unit 1154 indicates the license information of the organization license and service license to be canceled to the service providing license management unit 1124 corresponding to the sales region. At Step S76, the service providing license management unit 1124 changes the state of the indicated license information of the organization license and service license into “CANCELED”.

At Step S76, the service providing license management unit 1124 deletes all information that corresponds to the organization ID including the organization information, user information, device information, and the like. For example, to delete all the information that corresponds to the organization ID, the service providing license management unit 1124 indicates, for example, deletion of service authorization information to the authentication/authorization unit 1121 at Step S77. The service authorization information will be described later.

Note that in the sequence chart in FIG. 22, the service providing license management unit 1124 indicates the deletion to the authentication/authorization unit 1121 to delete authentication/authorization information. The service providing license management unit 1124 also indicates the deletion to the organization management unit 1122, the user management unit 1123, the device management unit 1125, and the like, depending on the information to be deleted.

According to the sequence chart in FIG. 22, in response to the indication of the cancellation of the organization license from the business license management unit 1154, it is possible for the service providing license management unit 1124 to cancel the organization license and to delete the information corresponding to the organization license. The information corresponding to the organization license may include a portal site and application setting information for an organization or a user. Note that in the sequence chart in FIG. 22, the license information has the state changed into “CANCELED”, but not deleted.

<<Canceling Service>>

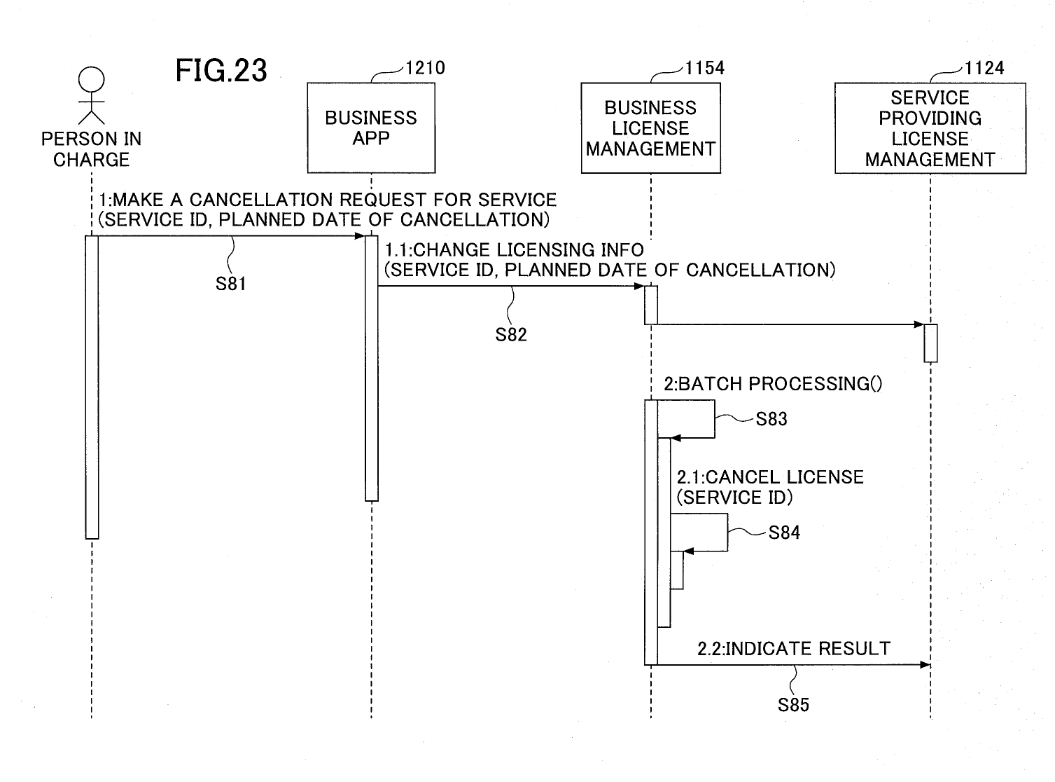

FIG. 23 is a sequence chart of an example of a procedure for canceling a service. At Step S81, a person in charge of business operates the business terminal 1201 and makes a request for canceling a service to the business application 1210. The request made at Step S81 includes the service ID and planned date of cancellation.

At Step S82, the business application 1210 makes a request for changing the license information of the service license to the business license management unit 1154. The request made at Step S82 includes the service ID and planned date of cancellation. After the execution of Step S82, the same request for changing the license information as at Step S82 is sent from the business license management unit 1154 to the service providing license management unit 1124 corresponding to the sales region of the organization ID to be canceled. When the planned date of cancellation comes, the business license management unit 1154 starts batch processing at Step S83. At Step S84, the business license management unit 1154 changes the state of the license information of the organization license and service license corresponding to the organization ID into “CANCELED”.

At Step S85, the business license management unit 1154 indicates the license information of the organization license and service license to be canceled to the service providing license management unit 1124 corresponding to the sales region. The service providing license management unit 1124 changes the state of the indicated license information of the organization license and service license into “CANCELED”.

<<Continuing Service Coming to an End>>

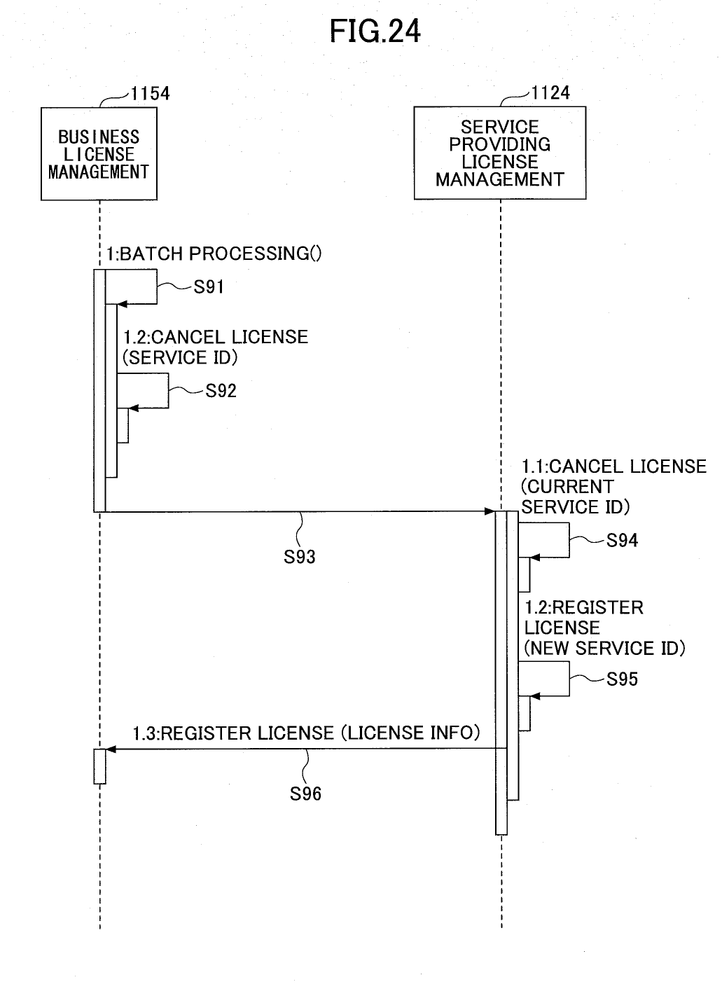

FIG. 24 is a sequence chart of an example of a procedure for continuing a service coming to an end. FIG. 24 illustrates the procedure that changes the state of the license information of the current license into “USE COMPLETED” and changes the state of the new license into “IN USE (NOT UPDATED)” on the planned date of cancellation of the current license.

When the planned date of cancellation comes, the business license management unit 1154 starts batch processing at Step S91. At Step S92, the business license management unit 1154 changes the state of the license information of the service license corresponding to the service ID into “CANCELED”.

At Step S93, the business license management unit 1154 indicates the license information of the service license to be canceled to the service providing license management unit 1124 corresponding to the sales region. At Step S94, the service providing license management unit 1124 changes the state of the license information corresponding to the service ID of the current license into “CANCELED”.

At Step S95, the service providing license management unit 1124 changes the state of the license information corresponding to the service ID of the new license into “REGISTERED”. Next, at Step S96, the service providing license management unit 1124 makes a request for registering the license information of the service license to the business license management unit 1154.

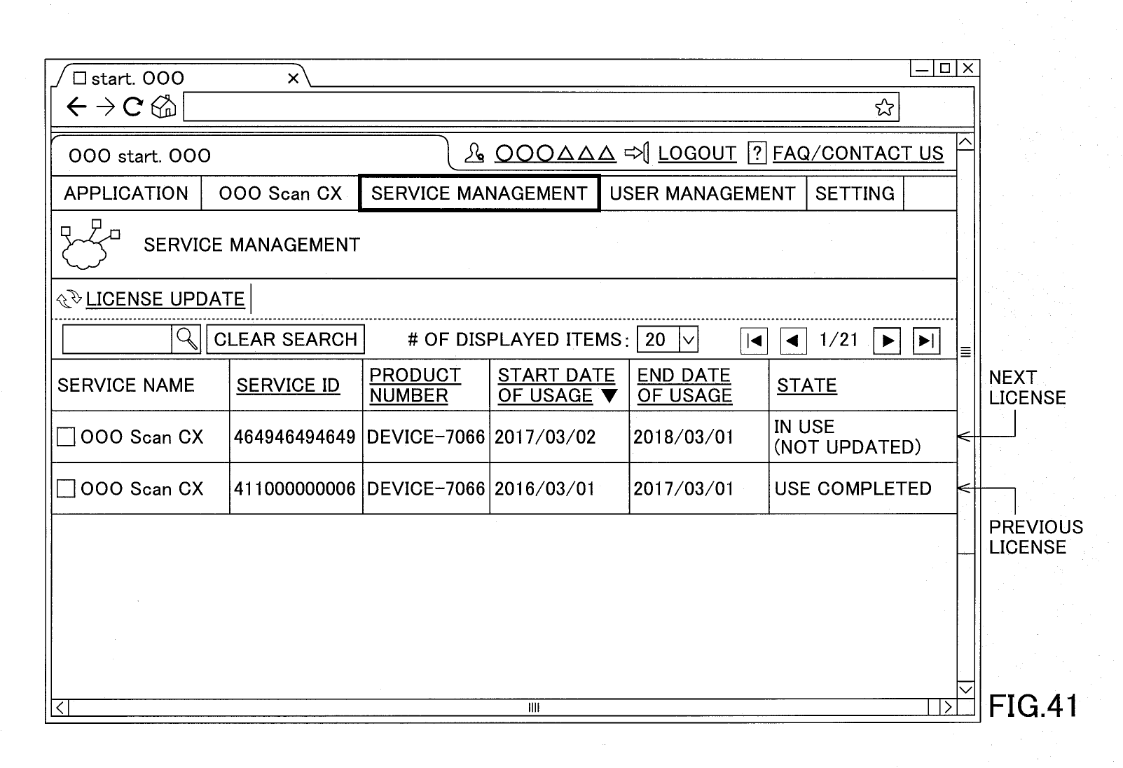

The service license is switched from the current license to the new license following the sequence chart in FIG. 24. After the switching from the current license to the new license has been completed, the service management screen illustrated in FIG. 40 changes to a service management screen illustrated in FIG. 41.

FIG. 41 is a schematic view illustrating an example of the service management screen on which a service is made to be continued by updating a license. On the service management screen in FIG. 41, the state of the license at the lower row that has been the current license in FIG. 40 has changed into “USE COMPLETED” from “IN USE (UPDATED)”. Also on the service management screen in FIG. 41, the state of the license at the upper row that has been the new license in FIG. 40 has changed into “IN USE (NOT UPDATED)” from “BEFORE USE”.

<<Displaying Service Selection Screen>>

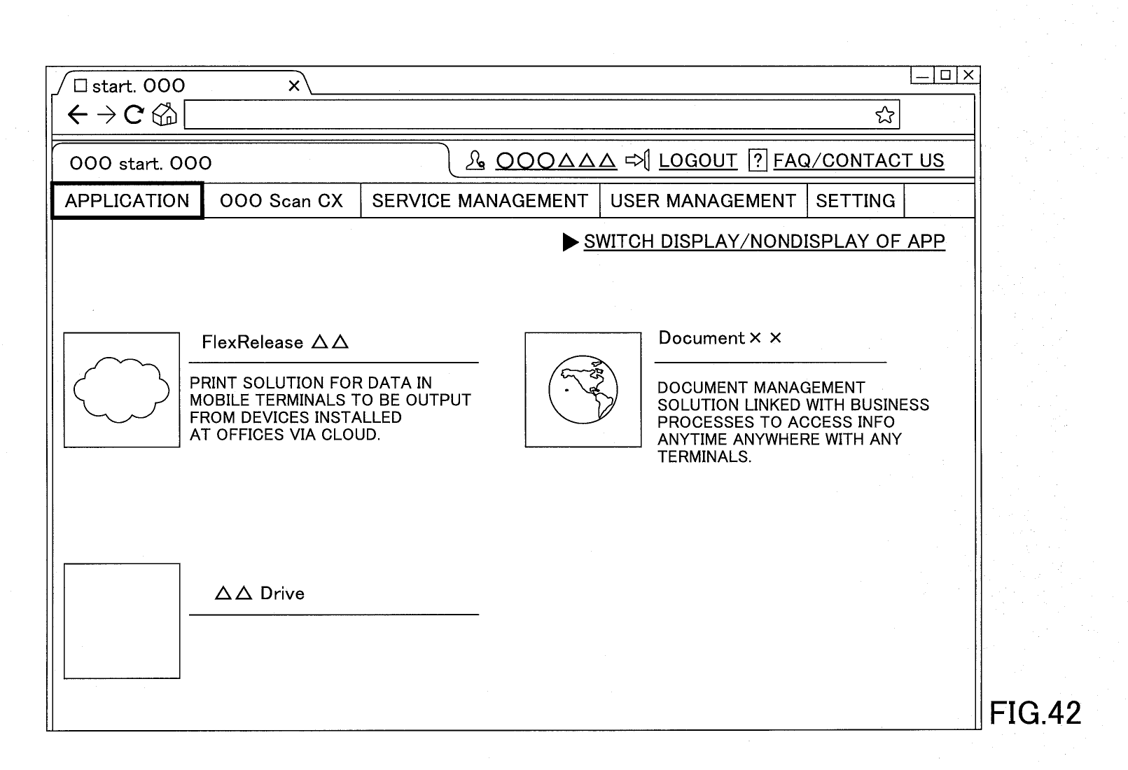

When a user accesses the portal service application 1111, the portal service application 1111 can have the user terminal 1202 display a service selection screen as illustrated in FIG. 42. FIG. 42 is a schematic view illustrating an example of the service selection screen. The service selection screen in FIG. 42 has screen elements, such as tabs and icons, provided for the accessing user to select a service among valid service licenses having the state of “IN USE” for the license information of the organization of the user if such licenses exist.

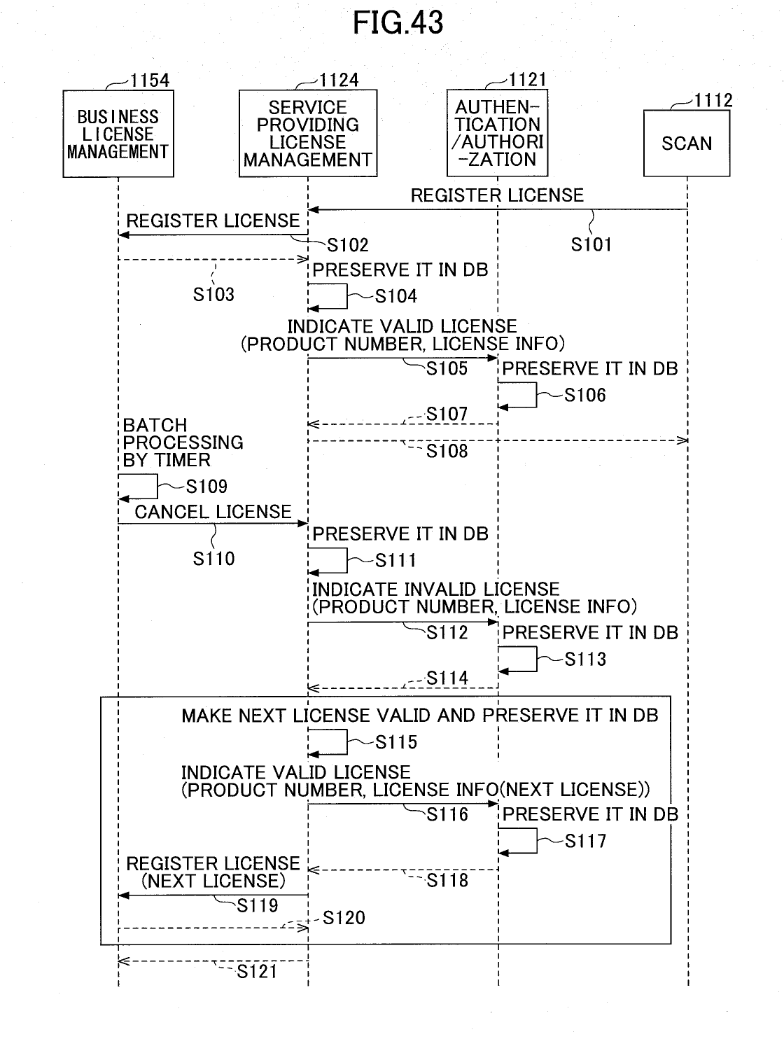

To display the service selection screen in FIG. 42, the service providing system 1100 preserves service authorization information as illustrated in FIG. 43. FIG. 43 is a sequence chart of an example of a procedure for preserving service authorization information. Note that for the same steps as in the previously described sequence charts, their description is appropriately omitted.

At Step S101, the scan service application 1112 makes a request for registering the service license to the service providing license management unit 1124. Note that the scan service application 1112 indicates the product number of the device to the service providing license management unit 1124 at Step S101.

At Step S102, the service providing license management unit 1124 makes a request for registering the service license to the business license management unit 1154. At Step S103, the business license management unit 1154 indicates a result of the registration of the service license to the service providing license management unit 1124.

If the result of the registration is successful, the service providing license management unit 1124 preserves the license information of the registered service license and the product number of the device into the license DB 1209 at Step S104.

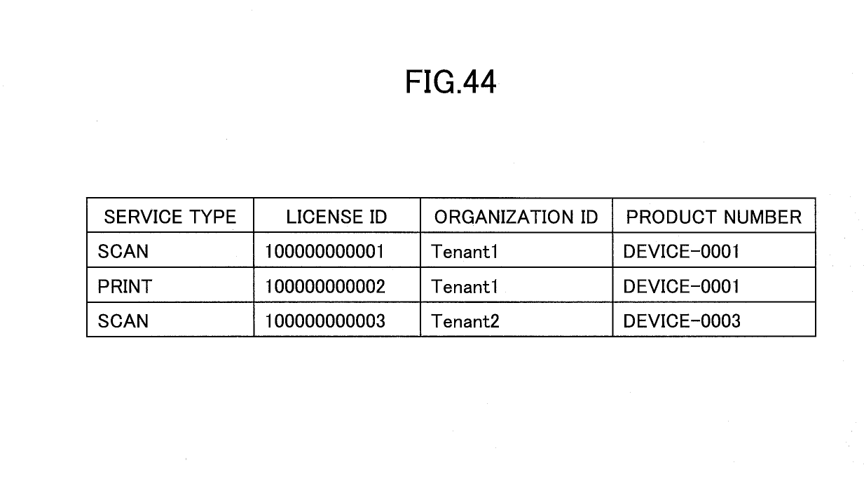

At Step S105, the service providing license management unit 1124 indicates to the authentication/authorization unit 1121 that the license is made valid. Note that the indication at Step S105 includes the license information of the service license that is made valid and the product number of the device for which the license is made valid. At Step S106, the authentication/authorization unit 1121 updates the service authorization information preserved in a service authorization table as illustrated in FIG. 44 if necessary, based on the indication at Step S105. The service authorization information is a list of services usable for an organization.

FIG. 44 is a schematic view illustrating a configuration diagram of an example of the service authorization table. The service authorization table in FIG. 44 includes, as data items, a service type, a license ID, an organization ID, and a product number. At Step S106, the service authorization information corresponding to the product number is added into the service authorization table in FIG. 44. Namely, in the service authorization table, a product number (a device for which a license is made valid) is preserved for each record of the license information.

At Step S107, the authentication/authorization unit 1121 returns a response to the indication at Step S105. At Step S108, the service providing license management unit 1124 indicates a result of the registration of the service license to the scan service application 1112.

When the planned date of cancellation of the service license comes, the business license management unit 1154 starts batch processing at Step S109. At Step S110, the business license management unit 1154 makes a request for canceling the service license to the service providing license management unit 1124.

At Step S111, the service providing license management unit 1124 reflects the license information of the canceled service license into the license DB 1209. At Step S112, the service providing license management unit 1124 indicates to the authentication/authorization unit 1121 that the license is made invalid. Note that the indication at Step S112 includes the license information of the service license that is made invalid by the cancellation and the product number of the device for which the license is made invalid. At Step S113, the authentication/authorization unit 1121 updates the service authorization information preserved in the service authorization table as illustrated in FIG. 44 if necessary, based on the indication at Step S112. At Step S113, the service authorization information corresponding to the product number of the device for which the license is made invalid is deleted in the service authorization table in FIG. 44.

Note that the authentication/authorization unit 1121 may preserve a subset of the license information as cache or the like. At Step S114, the authentication/authorization unit 1121 returns a response to the indication at Step S112.

If a next license is registered, the service providing license management unit 1124 continues the procedure to execute Step S115. The service providing license management unit 1124 reflects the license information of the next license to be registered into the license DB 1209.

At Step S116, the service providing license management unit 1124 indicates to the authentication/authorization unit 1121 that the license is made valid. Note that the indication at Step S116 includes the license information of the next license made valid by the registration and the product number of the device for which the license is made valid. At Step S117, the authentication/authorization unit 1121 updates the service authorization information preserved in the service authorization table in FIG. 44 if necessary, based on the indication at Step S116.

At Step S117, service authorization information corresponding to the product number of the device whose license is to be made valid is added to the service authorization table in FIG. 44. Next, at Step S118, the authentication/authorization unit 1121 returns a response to the indication at Step S116.

At Step S119, the service providing license management unit 1124 makes a request for registering the next license to the business license management unit 1154. At Step S120, the business license management unit 1154 indicates a result of the registration of the next license to the service providing license management unit 1124. Next, at Step S121, the service providing license management unit 1124 indicates a result of the cancellation of the current license to the business license management unit 1154.

According to the process illustrated in the sequence chart in FIG. 43, it is possible to improve response performance to generate a service selection screen and response performance to determine whether to execute a service with having the service authorization information generated.

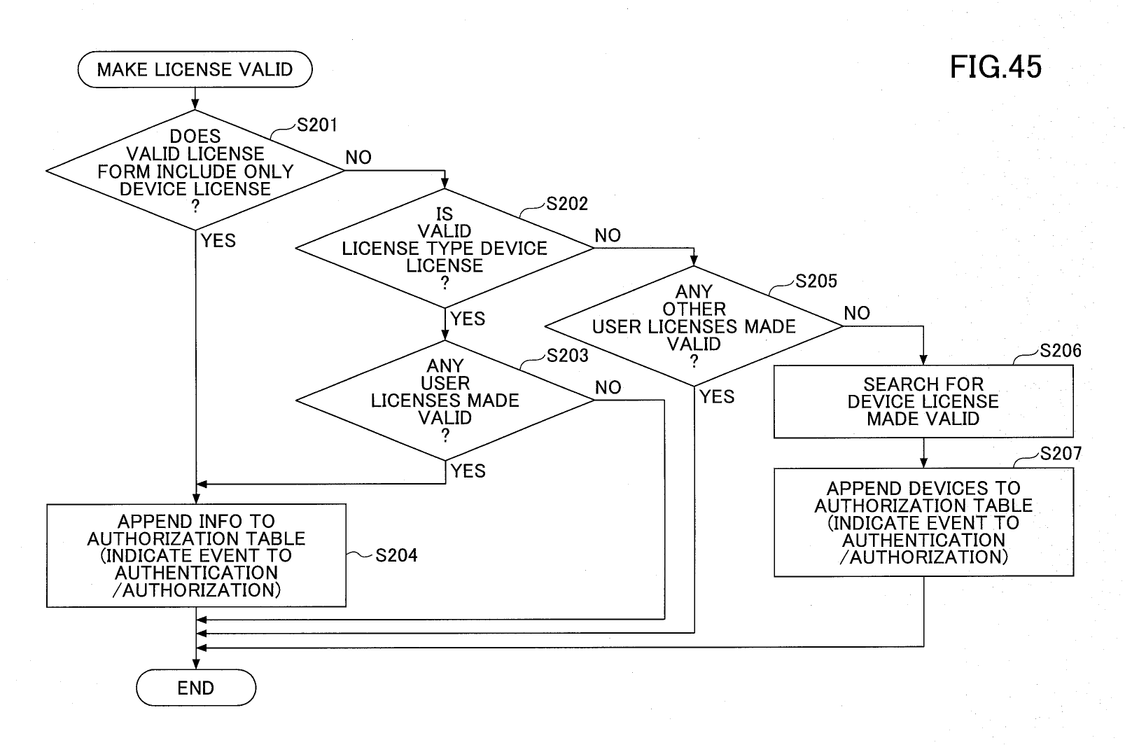

Note that in response to the indication that the license is made valid, the authentication/authorization unit 1121 adds the service authorization information in to the service authorization table in FIG. 44 by process steps for example, illustrated in FIG. 45. FIG. 45 is a flowchart of an example of a procedure for updating the service authorization table.

At Step S201, the authentication/authorization unit 1121 refers to the license information that is indicated to be made valid, and determines whether the license form is “device license only”.

If the license form is “device license only”, the authentication/authorization unit 1121 determines that the service licenses does not need to be combined. At Step S204, the authentication/authorization unit 1121 adds the service authorization information corresponding to the product number of the device whose license is to be made valid to the service authorization table.

If the license form is not “device license only”, the authentication/authorization unit 1121 determines that the service license needs to be combined, and proceeds to Step S202. The authentication/authorization unit 1121 determines whether the license type is “device license” for the license information that is indicated to be made valid.

If the license type is “device license”, the authentication/authorization unit 1121 proceeds to Step S203, and determines whether there exists license information whose license type is “user license”.

If there exists valid license information whose license type is “user license”, the authentication/authorization unit 1121 proceeds to Step S204, and adds the service authorization information to the service authorization table.

If there is no valid license information whose license type is “user license”, the authentication/authorization unit 1121 proceeds to Step S204, and does not add the service authorization information to the service authorization table.

At Step S202, if the license type is not “device license”, the authentication/authorization unit 1121 proceeds to Step S205, and determines whether there exists any other valid license information whose license type is “user license”.

If there exists some other valid license information whose license type is “user license”, the authentication/authorization unit 1121 does not add the service authorization information to the service authorization table.

If there is no other valid license information whose license type is “user license”, the authentication/authorization unit 1121 proceeds to Step S206, and searches for valid license information whose license type is “device license”.

The authentication/authorization unit 1121 proceeds to Step S207, and adds the service authorization information corresponding to the product number of the device whose license is valid to the service authorization table in FIG. 44 that is found in the search result of license information at Step S206.

Note that the search executed at Steps S203, S205 and S206 is executed for valid license information whose organization ID, service type and license form are the same as those of the license information to be indicated that the license is made valid.

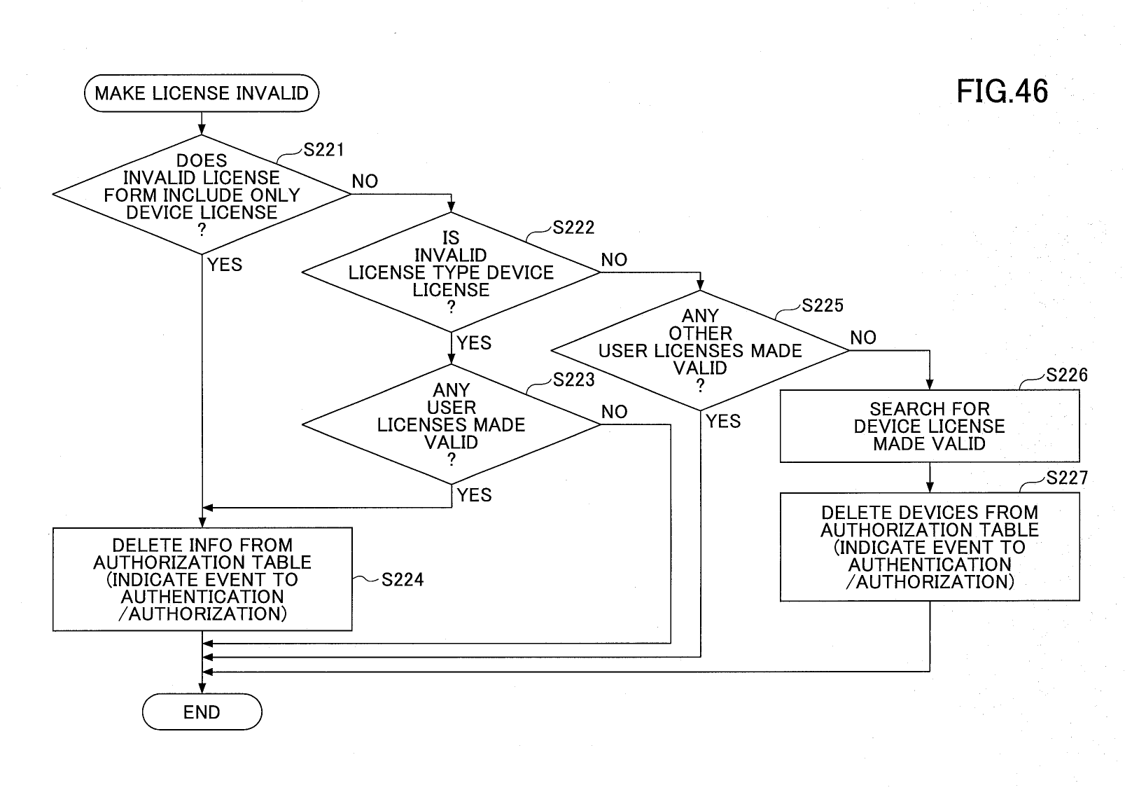

Also, in response to receiving an indication that a license is made invalid, the authentication/authorization unit 1121 deletes the service authorization information from the service authorization table in FIG. 44 by process steps, for example, illustrated in FIG. 46. FIG. 46 is a flowchart of another example of a procedure for updating the service authorization table.

At Step S221, the authentication/authorization unit 1121 refers to the license information that is indicated to be made invalid, and determines whether the license form is “device license only”.

If the license form is “device license only”, the authentication/authorization unit 1121 determines that the service license do not need to be combined. At Step S224, the authentication/authorization unit 1121 deletes the service authorization information corresponding to the product number of the device whose license is to be made invalid from the service authorization table.

If the license form is not “device license only”, the authentication/authorization unit 1121 determines that service licenses needs to be combined, and proceeds to Step S222. The authentication/authorization unit 1121 determines whether the license type is “device license” for the license information that is indicated to be made invalid.

If the license type is “device license”, the authentication/authorization unit 1121 proceeds to Step S223, and determines whether there exists license information whose license type is “user license”.

If there exists valid license information whose license type is “user license”, the authentication/authorization unit 1121 proceeds to Step S224, and deletes the service authorization information from the service authorization table.

If there is no valid license information whose license type is “user license”, the authentication/authorization unit 1121 does nothing.

At Step S222, if the license type is not “device license”, the authentication/authorization unit 1121 proceeds to Step S225, and determines whether there exists any other valid license information whose license type is “user license”.

If there exists some other valid license information whose license type is “user license”, the authentication/authorization unit 1121 does not delete it (does nothing).

If there exists no other valid license information whose license type is “user license”, the authentication/authorization unit 1121 proceeds to Step S226, and searches for valid license information whose license type is “device license”.

The authentication/authorization unit 1121 proceeds to Step S227, and adds the service authorization information corresponding to the product number of the device whose license is valid to the service authorization table in FIG. 44 that is found in the search result of license information at Step S226.

Note that the search executed at Steps S223, S225 and S226 is executed for valid license information whose organization ID, service type and license form are the same as those of the license information to be indicated that the license is made invalid.

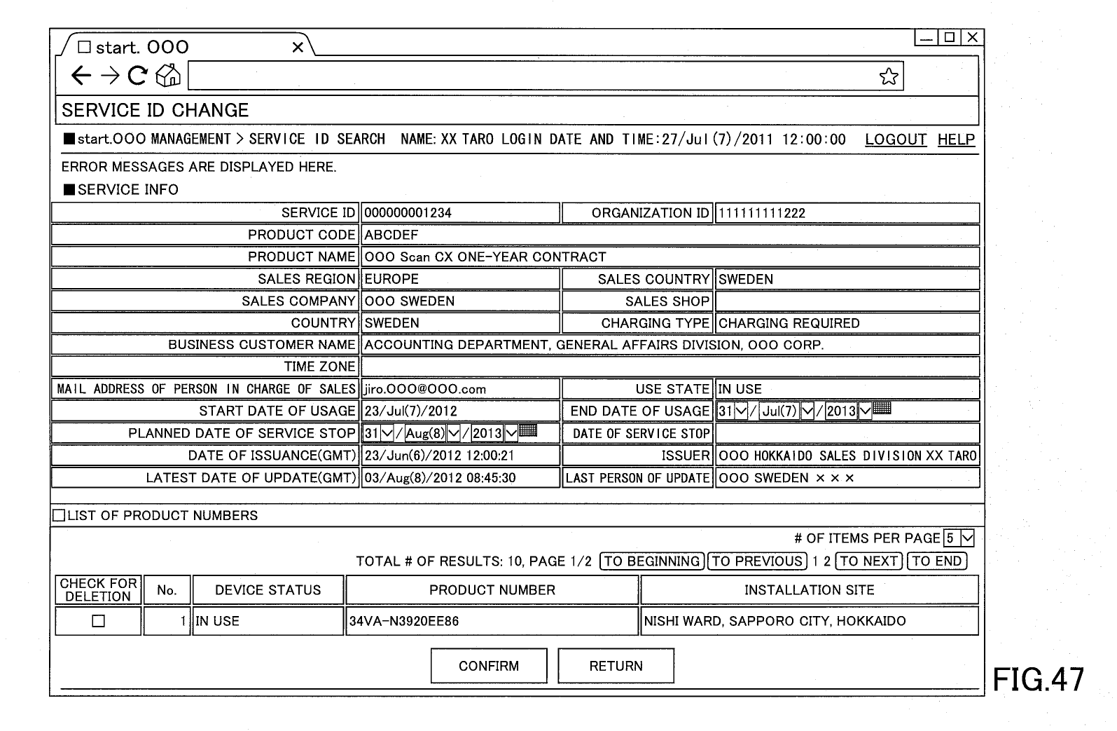

Note that cancellation of the service license at Step S110 may be requested by the person in charge of business on a service ID change screen illustrated in FIG. 47. FIG. 47 is a schematic view illustrating an example of the service ID change screen. The service ID change screen in FIG. 47 is displayed on, for example, the business terminal 1201. On the service ID change screen, a product number corresponding to an organization ID and a service ID can be displayed. For example, on the service ID change screen in FIG. 47, cancellation of the service license at Step S110 can be requested by inputting a check mark in a “CHECK FOR DELETION” box for the displayed product number.

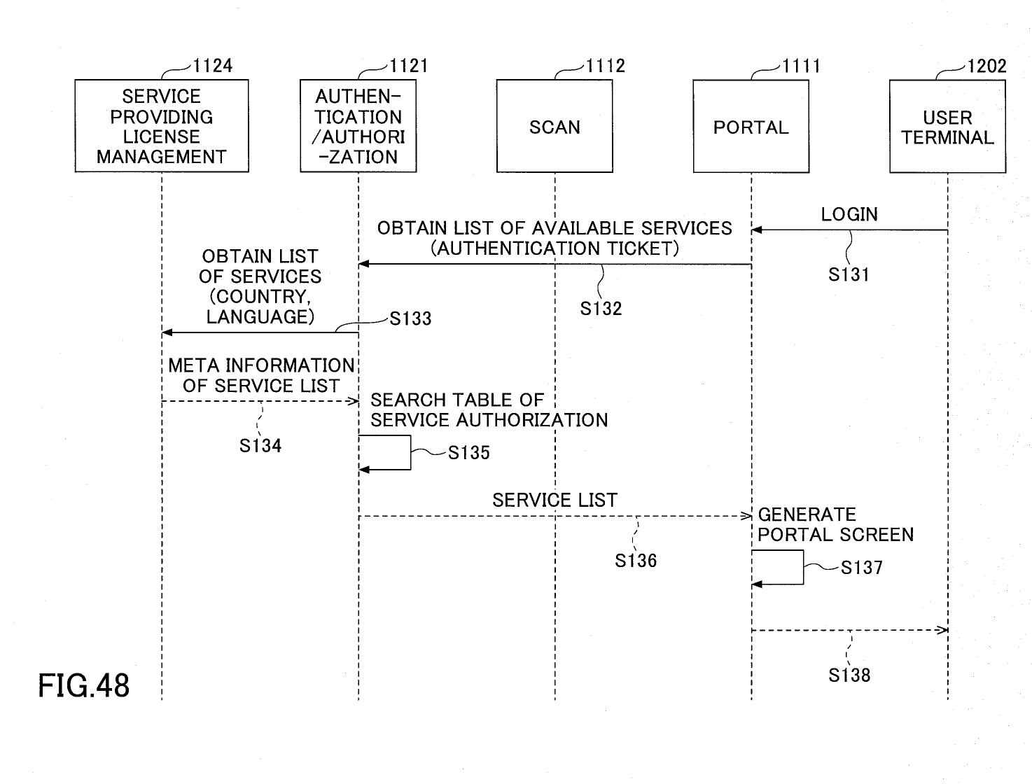

To generate the service selection screen in FIG. 42, a procedure illustrated in FIG. 48 is executed in the service providing system 1100. FIG. 48 is a sequence chart of an example of the procedure for generating the service selection screen.

At Step S131, a user operates the user terminal 1202 to login on the portal service application 1111. At Step S132, the portal service application 1111 presents an authentication ticket to the authentication/authorization unit 1121, to make a request for obtaining a usable service list.

At Step S133, the authentication/authorization unit 1121 specifies a country and a language to make a request for obtaining the service list. The service providing license management unit 1124 preserves a service master (meta information). Note that the service master includes, as data items, a service type, a descriptive text (for each language), an indication whether it is with or without license management, URLs (top, terms of use, and icons).

At Step S134, based on the service master, the service providing license management unit 1124 sends a service meta information list to the authentication/authorization unit 1121. At Step S135, the authentication/authorization unit 1121 searches for the service authorization information in the service authorization table in FIG. 44 to generate the usable service list.

Specifically, the authentication/authorization unit 1121 adds service authorization information for a service with license management that is registered in the service authorization table and has an organization ID and a service type equivalent to those of the login user's organization ID. Namely, if service authorization information is registered in the service authorization table in that the organization ID and service type are equivalent to those of the login user, the authentication/authorization unit 1121 determines that a service corresponding to the service type is usable.

Also, the authentication/authorization unit 1121 adds services without license management to the usable service list unconditionally. Note that the authentication/authorization unit 1121 may preserve setting that indicates usability of a service for each user. In this case, the authentication/authorization unit 1121 can generate a usable service list for each of the users.

At Step S136, the authentication/authorization unit 1121 sends the usable service list to the portal service application 1111. At Step S137, the portal service application 1111 generates a service selection screen illustrated in FIG. 42 using the received usable service list. Thus, at Step S138, the portal service application 1111 can display the service selection screen as illustrated in FIG. 42 on the user terminal 1202.

Note that the portal service application 1111 may obtain the service meta information list directly from the service providing license management unit 1124, and may generate the service selection screen as illustrated in FIG. 42 along with the service authorization information obtained from the authentication/authorization unit 1121.

According to the procedure illustrated in the sequence chart in FIG. 48, no access is generated to the business license management unit 1154, which improves response performance for displaying the service selection screen illustrated in FIG. 42. Also, according to the sequence chart in FIG. 48, if a valid service license exists, a service selection screen can be displayed with screen element such as tabs and icons for selecting a service corresponding to the service license.

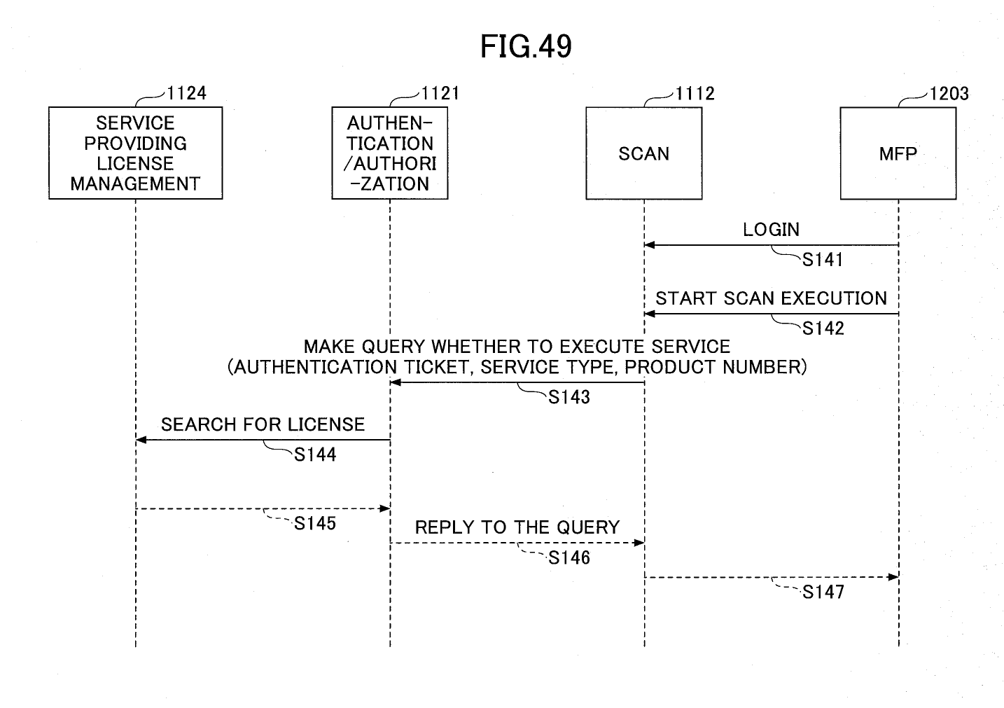

To determine whether to execute a service for a user, a procedure illustrated in FIG. 49 is executed in the service providing system 1100. FIG. 49 is a sequence chart of an example of the procedure for determining whether to allow service execution.

At Step S141, a user operates the MFP 1203 to login on the scan service application 1112. At Step S142, the user operates the MFP 1203 to issue a command of scan execution. The MFP 1203 makes a request for scan execution to the scan service application 1112.

At Step S143, the scan service application 1112 specifies an authentication ticket, a service type, and a product number, and makes a query to the authentication/authorization unit 1121 whether a scan service can be executed by the MFP 1203. The authentication/authorization unit 1121 proceeds to Step S144, specifies the service type and product number, and makes a request for searching for license information.

Note that instead of Step S144, the authentication/authorization unit 1121 may allow executing a scan service if service authorization information is registered in the service authorization table that has the coincident organization ID, service type and product number. As the organization ID, for example, that included in the authentication ticket can be used.

The service providing license management unit 1124 specifies the service type and product number, and searches for license information. At Step S145, the service providing license management unit 1124 sends searched license information to the authentication/authorization unit 1121. The service providing license management unit 1124 can determine whether the scan service can be executed by the MFP 1203 by confirming the state of the license information received from the service providing license management unit 1124.

Note that the authentication/authorization unit 1121 may preserve a subset of license information as cache or the like. Also, the authentication/authorization unit 1121 may preserve setting that indicates usability of a service for each user. In this case, the authentication/authorization unit 1121 can generate a usable service list for each of the users. In this case, the authentication/authorization unit 1121 determines whether the scan service can be executed by the MFP 1203 based on the setting that indicates usability of the service for each of the users.

Next, the authentication/authorization unit 1121 indicates to the scan service application 1112 whether the scan service can be executed by the MFP 1203. At Step S147, the scan service application 1112 indicates to the MFP 1203 whether to execute the scan service. If the scan cannot be executed, the MFP 1203 displays an error, for example. If the scan can be executed, the MFP 1203 starts executing the scan.

According to the procedure illustrated in the sequence chart in FIG. 49, no access is generated to the business license management unit 1154, which improves response performance for starting scan execution. Also, according to the procedure illustrated in the sequence chart in FIG. 49, if a valid service license exists, a job execution of a service corresponding to the service license can be allowed.

(Overview)

The service providing system 1100 according to the first embodiment includes the service providing license management unit 1124 and the business license management unit 1154, which makes license management easier because differences among multiple business system is absorbed by the business license management unit 1154.

Therefore, the service providing system 1100 according to the first embodiment can easily apply usage restriction to the applications 1101 using various licenses issued by multiple business system.

The present invention is not limited to the specific embodiments described herein, and variations and modifications may be made without departing from the spirit and scope of the present invention.

The present application is based on and claims the benefit of priority of Japanese Priority Patent Application No. 2013-021834, filed on Feb. 6, 2013, and Japanese Priority Patent Application No. 2013-257095, filed on Dec. 12, 2013, the entire contents of which are hereby incorporated herein by reference.

What is claimed is:

1. An information processing system including one or more information processing apparatuses, the information processing apparatus comprising:
one or more service providing units configured to provide a service to a first terminal device; and
a license management unit configured to manage a license temporarily registered from a second terminal device,
wherein the service providing unit includes
a first storage unit configured to preserve license information of the license managed by the license management unit,
a second storage unit configured to store a copy of the license information of the license, and
a validation unit configured to receive a request to make the license valid from the first terminal device, to make the temporarily registered license information of the license stored in the second storage unit valid, and to request to make the temporarily registered license information of the license preserved in the first storage unit valid,
wherein the service is provided for the first terminal device based on the license having been made valid.

2. The information processing system as claimed in claim 1, wherein the license for using the service providing unit includes a first license for using the service providing unit and a second license for using one of services provided by the service providing unit,
wherein the first license and the second license are associated with each other and stored.

3. The information processing system as claimed in claim 2, wherein the first license and the second license have a parent-child relationship where the first license is a parent license and the second license is a child license.

4. The information processing system as claimed in claim 2, wherein the service providing unit provides the service for the first terminal device when the first license and the second license are valid.

5. The information processing system as claimed in claim 1, wherein the service providing unit further receives a request to update the license from the first terminal device, makes the temporarily registered license information of the license stored in the second storage unit be a license to be made valid, following the license having been made valid, and updates the license information stored in the first storage unit and the second storage unit.

6. The information processing system as claimed in claim 5, wherein the license information includes, as data items, an end date of contract of the license and a planned date of cancellation when the license is to be made invalid,
wherein, when making the license valid based on the request to make the license valid, the service providing unit sets a day obtained by adding a predetermined number of days to the end date of contract as the planned date of cancellation of the license,
wherein, when making the license valid based on the request to update the license, the service providing unit sets the planned date of cancellation of the license to be the same date as the end date of contract.

7. The information processing system as claimed in claim 6, wherein the license management unit includes
an invalidation setting unit configured to receive a request of cancellation of the license from the second terminal device, to set a state of the license information stored in the first storage unit to indicate the cancellation, and to set a state of the license information stored in the second storage unit to indicate the cancellation, and
an invalidation unit configured to make the license invalid on the planned date of cancellation of the license information.

8. The information processing system as claimed in claim 3, wherein the service providing unit deletes information corresponding to the first license when making the first license, as the parent license, invalid.

9. The information processing system as claimed in claim 1, wherein the license management unit receives a request of temporary registration, change or cancellation of the license specified with a region from the second terminal device, and indicates the license temporarily registered, changed or canceled based on the request from the second terminal device, to the service providing unit corresponding to the specified region.

10. The information processing system as claimed in claim 4, wherein the service providing unit includes a service authorization information storage section configured to preserve service authorization information to associate the first license and the second license with the first terminal device providing the service, when the first license and the second license are valid, and
a determination unit configured to determine whether to provide the service for the first terminal device using the service authorization information preserved in the service authorization information storage section.

11. The information processing system as claimed in claim 10, wherein, when the first license and the second license are newly made valid, the service providing unit further includes an addition unit configured to add the service authorization information to the service authorization information storage section if a license form of the second license having been made valid is a license form to allow providing the service without being combined with another second license.

12. The information processing system as claimed in claim 11, wherein if the license form of the second license made valid is a license form to allow providing the service with being combined with the other second license, the addition unit adds the service authorization information to the service authorization information storage section if there exists the other second license having been made valid.

13. The information processing system as claimed in claim 10, wherein, when the first license and the second license are newly made invalid, the service providing unit further includes a deletion unit configured to delete the service authorization information from the service authorization information storage section if a license form of the second license made invalid is a license form to allow providing the service without being combined with another second license.

14. The information processing system as claimed in claim 13, wherein if the license form of the second license made invalid is a license form to allow providing the service with being combined with the other second license, the deletion unit deletes the service authorization information from the service authorization information storage section if the other second license made invalid does not exist.

15. An information processing apparatus comprising:
one or more service providing units configured to provide a service to a first terminal device; and
a license management unit configured to manage a license temporarily registered from a second terminal device,
wherein the service providing unit includes
a first storage unit configured to preserve license information of the license managed by the license management unit,
a second storage unit configured to store a copy of the license information of the license, and
a validation unit configured to receive a request to make the license valid from the first terminal device, to make the temporarily registered license information of the license stored in the second storage unit valid, and to request to make the temporarily registered license information of the license preserved in the first storage unit valid,
wherein the service is provided for the first terminal device based on the license having made valid.

16. A license management method executed by an information processing system including one or more information processing apparatus, the method comprising:
having the information processing system provide
one or more service providing units configured to provide a service to a first terminal device; and
a license management unit configured to manage a license temporarily registered from a second terminal device,
having the service providing unit
preserve license information of the license managed by the license management unit into a first storage unit, and store a copy of the license information of the license into a second storage unit,
receive a request to make the license valid from the first terminal device to make the temporarily registered license information of the license stored in the second storage unit valid,
request to make the temporarily registered license information of the license preserved in the first storage unit valid, and
provide the service for the first terminal device based on the license having made valid.
